(19) United States
(12) Patent Application Publication
(10) Pub. No.: US 2024/0286411 A1
(43) Pub. Date: Aug. 29, 2024

(54) Liquid Ejecting Head And Liquid Ejecting Apparatus

(71) Applicant: SEIKO EPSON CORPORATION, Tokyo (JP)

(72) Inventors: Haruki KOBAYASHI, Matsumoto (JP); Shun KATSUIE, Matsumoto (JP)

(21) Appl. No.: 18/586,636

(22) Filed: Feb. 26, 2024

(30) Foreign Application Priority Data
Feb. 27, 2023 (JP) 2023-028146

(51) Int. Cl. B41J 2/175; B41J 2/14

(52) U.S. Cl. CPC B41J 2/175; B41J 2/1433; B41J 2202/13; B41J 2202/14; B41J 2202/22

(57) ABSTRACT

A liquid ejecting head includes a flow path structure having a first coupling flow path, a first head chip having a second coupling flow path that communicates with first nozzles, and a first joint member having a first relay flow path that communicates with the first coupling flow path and the second coupling flow path, in which the first joint member is detachably fixed to the flow path structure so that the first coupling flow path and the first relay flow path are coupled to each other, and the second coupling flow path and the first relay flow path liquid-tightly communicate with each other via an adhesive disposed around an opening of the first relay flow path facing the second coupling flow path.

The present application is based on, and claims priority from JP Application Serial Number 2023-028146, filed Feb. 27, 2023, the disclosure of which is hereby incorporated by reference herein in its entirety.

### BACKGROUND

### 1. Technical Field

The present disclosure relates to a liquid ejecting head and a liquid ejecting apparatus.

### 2. Related Art

In the related art, a liquid ejecting apparatus typified by an ink jet type printer generally includes a liquid ejecting head that ejects a liquid such as an ink as a droplet.

For example, a liquid ejecting head disclosed in JP-A-2015-39804 includes a head chip that ejects an ink from a nozzle, and a flow path structure that holds the head chip and supplies an ink to the head chip. Here, the head chip is provided with an inlet, and the head chip is fixed to a flow path member by an adhesive provided around the inlet, whereby the inlet is liquid-tightly coupled to an outlet of a flow path of the flow path structure.

In the liquid ejecting head, for example, when the head chip fails, there is a demand to regenerate the liquid ejecting head by replacing only the head chip. In addition, when a portion of the liquid ejecting head other than the head chip fails, there is a demand to reuse the head chip by detaching the non-failed head chip from the flow path structure and mounting it on another liquid ejecting head.

However, in the liquid ejecting head disclosed in JP-A-2015-39804, since the inlet of the head chip and the outlet of the flow path structure are coupled to each other via the adhesive, when the head chip and the flow path structure are separated from each other, adhesive residue may be generated thereon. Therefore, it is difficult to regenerate the liquid ejecting head by replacing the head chip or to reuse the head chip as a portion of another liquid ejecting head.

### SUMMARY

According to an aspect of the present disclosure, there is provided a liquid ejecting head including: a flow path structure having a first coupling flow path; a first head chip having a plurality of first nozzles that eject a liquid and a second coupling flow path that communicates with the plurality of first nozzles; and a first joint member having a first relay flow path that communicates with the first coupling flow path and the second coupling flow path, in which the first joint member is detachably fixed to the flow path structure so that the first coupling flow path and the first relay flow path are coupled to each other, and the second coupling flow path and the first relay flow path liquid-tightly communicate with each other via an adhesive disposed around an opening of the first relay flow path facing the second coupling flow path.

According to another aspect of the present disclosure, there is provided a liquid ejecting head including: a flow path structure having a first coupling flow path; a head chip having a plurality of nozzles that eject a liquid and a second coupling flow path that communicates with the plurality of nozzles and that communicates with the first coupling flow path; and a second joint member having a second relay flow path that communicates with the first coupling flow path and the second coupling flow path, in which the second joint member is detachably fixed to the head chip so that the second coupling flow path and the second relay flow path are coupled to each other, and the first coupling flow path and the second relay flow path liquid-tightly communicate with each other via an adhesive disposed around an opening of the second relay flow path facing the first coupling flow path.

According to still another aspect of the present disclosure, there is provided a liquid ejecting apparatus including: the liquid ejecting head according to any one of the above-described aspects; and a liquid storage portion for storing a liquid supplied to the liquid ejecting head.

### BRIEF DESCRIPTION OF THE DRAWINGS

FIG. 1 is a schematic view illustrating a configuration example of a liquid ejecting apparatus according to a first embodiment.

FIG. 2 is a cross-sectional view illustrating an example of a head chip.

FIG. 3 is a top view of a liquid ejecting head according to the first embodiment.

FIG. 4 is a cross-sectional view taken along the line IV-IV in FIG. 3.

FIG. 5 is a bottom view of the liquid ejecting head according to the first embodiment.

FIG. 6 is a cross-sectional view taken along the line VI-VI in FIG. 3.

FIG. 7 is a cross-sectional view taken along the line VII-VII in FIG. 6.

FIG. 8 is a schematic plan view for describing a first fixing position and a second fixing position according to the first embodiment.

FIG. 9 is a view for describing an assembly of the liquid ejecting head according to the first embodiment.

FIG. 10 is a view for describing detachment of the head chip from the liquid ejecting head according to the first embodiment.

FIG. 11 is a view for describing reusing of the head chip in the first embodiment.

FIG. 12 is a view for describing regenerating of the liquid ejecting head in the first embodiment.

FIG. 13 is a cross-sectional view of a liquid ejecting head according to a second embodiment.

FIG. 14 is a cross-sectional view taken along the line XIV-XIV in FIG. 13.

FIG. 15 is a schematic plan view for describing a first fixing position and a second fixing position according to the second embodiment.

FIG. 16 is a cross-sectional view of a liquid ejecting head according to a third embodiment.

FIG. 17 is a view for describing a first joint member of a liquid ejecting head according to a fourth embodiment.

FIG. 18 is a view for describing a first joint member of a liquid ejecting head according to a fifth embodiment.

FIG. 19 is a view for describing a first joint member of a liquid ejecting head according to a sixth embodiment.

FIG. 20 is a view for describing a first joint member of a liquid ejecting head according to a seventh embodiment.

FIG. 21 is a view for describing a first joint member of a liquid ejecting head according to an eighth embodiment.

FIG. 22 is a cross-sectional view of a liquid ejecting head according to Modification Example 1.

FIG. 23 is a cross-sectional view of a liquid ejecting head according to Modification Example 2.

### DESCRIPTION OF EMBODIMENTS

Hereinafter, preferred embodiments according to the present disclosure will be described with reference to the accompanying drawings. In the drawings, dimensions or scales of each portion are appropriately different from actual ones, and for easy understanding, some portions are schematically illustrated. In addition, the scope of the present disclosure is not limited to these forms unless it is stated in the following description that the present disclosure is particularly limited.

The following description will be performed by using an X axis, a Y axis, and a Z axis that intersect each other as appropriate. In addition, one direction along the X axis is referred to as an X1 direction, and a direction opposite to the X1 direction is referred to as an X2 direction. Similarly, directions opposite to each other along the Y axis are referred to as a Y1 direction and a Y2 direction. In addition, directions opposite to each other along the Z axis are referred to as a Z1 direction and a Z2 direction. Here, the Z1 direction or the Z2 direction is an example of a “stacking direction of a head chip and a flow path structure” which will be described below. In addition, viewing in the direction along the Z axis is referred to as “plan view”.

Here, typically, the Z axis is a vertical axis, and the Z2 direction corresponds to a downward direction in the vertical direction. Note that the Z axis does not have to be the vertical axis. In addition, the X axis, the Y axis, and the Z axis are typically orthogonal to each other. However, without being limited to this, all of these need only intersect each other at an angle within a range of, for example, 80° or more and 100° or less.

### 1. FIRST EMBODIMENT

### 1-1. Schematic Configuration of Liquid Ejecting Apparatus

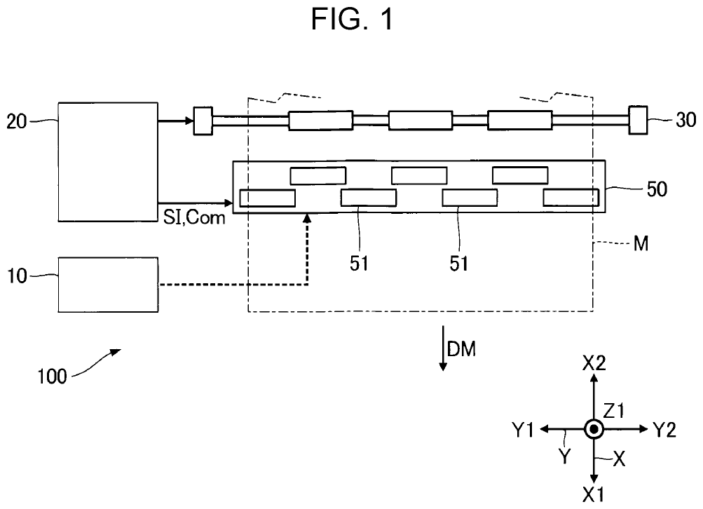

FIG. 1 is a schematic view illustrating a configuration example of a liquid ejecting apparatus 100 according to a first embodiment. The liquid ejecting apparatus 100 is an ink jet type printing apparatus that ejects ink which is an example of liquid onto a medium M as a droplet. The medium M is typically printing paper. The medium M is not limited to the printing paper, and may be, for example, a printing target made of any material such as a resin film or cloth.

As illustrated in FIG. 1, the liquid ejecting apparatus 100 has a liquid storage portion 10, a control unit 20, a transport mechanism 30, and a liquid ejecting head 50.

The liquid storage portion 10 is a container that stores an ink. Specific examples of the liquid storage portion 10 include a cartridge that is detachable from the liquid ejecting apparatus 100, a bag-shaped ink pack formed of a flexible film, and an ink tank that can be refilled with an ink. A type of the ink stored in the liquid storage portion 10 is not particularly limited, and is set in any desired way.

The control unit 20 controls an operation of each element of the liquid ejecting apparatus 100. For example, the control unit 20 includes a process circuit such as a central processing unit (CPU) or a field programmable gate array (FPGA) and a storage circuit such as a semiconductor memory, and controls an operation of each element of the liquid ejecting apparatus 100.

The transport mechanism 30 transports a medium M in a direction DM under control of the control unit 20. The direction DM of the present embodiment is the X1 direction. In an example illustrated in FIG. 1, the transport mechanism 30 includes a long transport roller along the Y axis and a motor that rotates the transport roller. The transport mechanism 30 is not limited to the configuration using the transport roller, and may be configured to use, for example, a drum or an endless belt that transports the medium M in a state in which the medium M is attracted to an outer peripheral surface by electrostatic force or the like.

Under the control of the control unit 20, the liquid ejecting head 50 ejects the ink supplied from the liquid storage portion 10 onto the medium M in the Z2 direction from each of a plurality of nozzles N. The liquid ejecting head 50 is a line head that has a plurality of head chips 51 disposed such that the plurality of nozzles are distributed over the entire range of the medium M in the direction along the X axis, and that is elongated in the direction in which the X axis extends. When the ejection of the ink from the liquid ejecting head 50 is performed in parallel with the transport of the medium M by the transport mechanism 30, an image is formed at a surface of the medium M by means of the ink.

The number and the disposition of the head chips 51 included in the liquid ejecting head 50 are not limited to the example illustrated in FIG. 1, and are set in any desired way. In addition, when the liquid ejecting head 50 is configured to circulate the ink, the liquid ejecting head 50 may be coupled to the liquid storage portion 10 via a circulation mechanism for circulating the ink in the liquid ejecting head 50.

### 1-2. Configuration Example of Head Chip

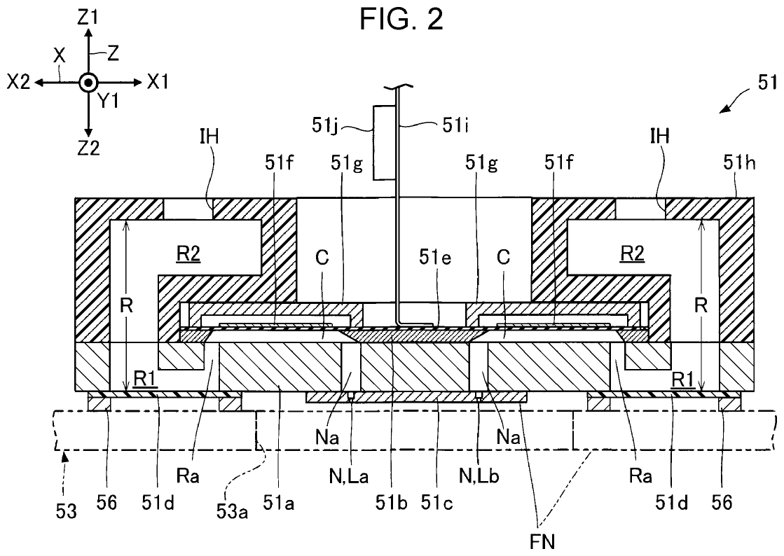

FIG. 2 is a cross-sectional view illustrating an example of the head chip 51. The head chip 51 has a substantially symmetrical configuration in the direction along the X axis. Note that positions of a plurality of nozzles N of a nozzle row La and a plurality of nozzles N of a nozzle row Lb in the direction along the Y axis may coincide with or may be different from each other. FIG. 2 illustrates a configuration in which the positions of the plurality of nozzles N of the nozzle row La and the plurality of nozzles N of the nozzle row Lb in the direction along the Y axis coincide with each other.

As illustrated in FIG. 2, the head chip 51 includes a flow path substrate 51a, a pressure chamber substrate 51b, a nozzle plate 51c, a vibration absorbing body 51d, a vibration plate 51e, a plurality of drive elements 51f, a protective plate 51g, a case 51h, and a wiring substrate 51i.

The flow path substrate 51a and the pressure chamber substrate 51b are stacked in this order in the Z1 direction, and form a flow path for supplying the ink to the plurality of nozzles N. The vibration plate 51e, the plurality of drive elements 51f, the protective plate 51g, the case 51h, and the wiring substrate 51i are installed in a region located in the Z1 direction with respect to a stacked body formed of the flow path substrate 51a and the pressure chamber substrate 51b. On the other hand, the nozzle plate 51c and the vibration absorbing body 51d are installed in a region located in the Z2 direction with respect to the stacked body. Each element of the head chip 51 is schematically a plate-shaped member elongated in the Y direction, and the elements are joined to each other by, for example, using an adhesive. In the following, each element of the head chip 51 will be described in order.

The nozzle plate 51c is a plate-shaped member provided with the plurality of nozzles N of each of the nozzle row La and the nozzle row Lb. Each of the plurality of nozzles N is a through-hole through which an ink passes. A surface of the nozzle plate 51c facing the Z2 direction constitutes a portion of an ejection surface FN.

A space R1, a plurality of individual flow paths Ra, and a plurality of communication flow paths Na are provided in the flow path substrate 51a for each of the nozzle row La and the nozzle row Lb. The space R1 is an elongated opening extending in the direction along the Y axis in plan view in the direction along the Z axis. Each of the individual flow paths Ra and the communication flow paths Na is a through-hole formed for each nozzle N. Each individual flow path Ra communicates with the space R1. In the present specification, the term “communication” includes not only an aspect in which two target spaces are directly coupled to form one space but also an aspect in which two target spaces are coupled via another space to form one space.

The pressure chamber substrate 51b is a plate-shaped member provided with a plurality of pressure chambers C for each of the nozzle row La and the nozzle row Lb. The plurality of pressure chambers C are arranged in the direction along the Y axis. Each of the pressure chambers C is formed for each nozzle N, and is an elongated space extending in the direction along the X axis in plan view.

The pressure chamber C is a space located between the flow path substrate 51a and the vibration plate 51e. The plurality of pressure chambers C are arranged in the direction along the Y axis for each of the nozzle row La and the nozzle row Lb. In addition, the pressure chamber C communicates with each of the communication flow path Na and the individual flow path Ra. Therefore, the pressure chamber C communicates with the nozzle N via the communication flow path Na, and communicates with the space R1 via the individual flow path Ra.

The vibration plate 51e is disposed on a surface of the pressure chamber substrate 51b facing the Z1 direction. The vibration plate 51e is a plate-shaped member that can elastically vibrate. For example, the vibration plate 51e has an elastic film made of silicon oxide (SiO₂) and an insulating film made of zirconium oxide (ZrO₂), and these films are stacked in this order in the Z1 direction. The vibration plate 51e is not limited to the above-described configuration in which the elastic film and the insulating film are stacked, and may be, for example, configured of a single layer or three or more layers.

The plurality of drive elements 51f mutually corresponding to the nozzles N are disposed on a surface of the vibration plate 51e facing the Z1 direction for each of the nozzle row La and the nozzle row Lb. Each of the drive elements 51f is a passive element that deforms when supplied with a drive signal. Each drive element 51f has an elongated shape extending in the direction along the X axis in plan view. The plurality of drive elements 51f are arranged in the direction along the Y axis to correspond to the plurality of pressure chambers C. The drive element 51f overlaps the pressure chamber C in plan view.

Each drive element 51f is a piezoelectric element, and although not illustrated, the drive element 51f has a first electrode, a piezoelectric body layer, and a second electrode, which are stacked in this order in the Z1 direction. One of the first electrode and the second electrode is an individual electrode disposed to be separated from another electrode of the same type for each drive element 51f, and a drive signal Com is supplied to the one electrode. The other electrode of the first electrode and the second electrode is a band-shaped common electrode extending in the direction along the Y axis to be continuous over the plurality of drive elements 51f, and for example, a constant potential is supplied to the other electrode. The piezoelectric body layer is made of a piezoelectric material such as lead zirconate titanate (Pb(Zr,Ti)O₃), and for example, has a band shape extending in the direction along the Y axis to be continuous over the plurality of drive elements 51f. Note that the piezoelectric body layer may be integrated over the plurality of drive elements 51f. In this case, the piezoelectric body layer is provided with a through-hole penetrating the piezoelectric body layer to extend in the direction along the X axis in a region corresponding to, in plan view, a gap between the pressure chambers C adjacent to each other. When the vibration plate 51e vibrates in conjunction with deformation of the drive element 51f due to the supply of the drive signal Com to the individual electrode, the pressure inside the pressure chambers C fluctuates and the ink is ejected from the nozzle N. The drive element 51f is not limited to a piezoelectric element, and may be a heat generating element that ejects the ink from the nozzle N using a bubble generated by generating heat in the ink in the pressure chamber C.

The protective plate 51g is a plate-shaped member installed on the surface of the vibration plate 51e facing the Z1 direction, protects the plurality of drive elements 51f, and reinforces mechanical strength of the vibration plate 51e. Here, the plurality of drive elements 51f are accommodated between the protective plate 51g and the vibration plate 51e.

The case 51h is a member for storing the ink to be supplied to the plurality of pressure chambers C. For example, the case 51h is made of a resin material. The case 51h is provided with a space R2 for each of the nozzle row La and the nozzle row Lb. The space R2 is a space communicating with the above-described space R1, and functions as a reservoir R that stores the ink to be supplied to the plurality of pressure chambers C together with the space R1. The case 51h is provided with an inlet IH for supplying the ink to each reservoir R. The ink in each reservoir R is supplied to the pressure chamber C via each individual flow path Ra.

In the present embodiment, two inlets IH are provided for one reservoir R. One inlet IH of the two inlets IH is coupled to an end of the reservoir R in the Y1 direction, and the other inlet IH is coupled to an end of the reservoir R in the Y2 direction. In this way, one head chip 51 is provided with four inlets IH. The number of the inlets IH provided in one head chip 51 is not limited to four, and may be, for example, one or three or more for one reservoir R. In addition, the disposition of the inlet IH is not limited to the disposition in which the inlet IH is coupled to the end of the reservoir R in the Y1 direction or in the Y2 direction, and may be, for example, the disposition in which the inlet IH is coupled to the center of the reservoir R in the Y axis direction. Each inlet IH extends in a stacking direction of the head chip 51 and the flow path structure 52 which will be described below.

The stacking direction of the head chip 51 and the flow path structure 52 is a direction along the Z axis in which a head chip 51-1 and the flow path structure 52 are stacked. Here, the stacking of the head chip 51-1 and the flow path structure 52 may include the indirect stacking of the head chip 51-1 and the flow path structure 52, that is, a joint structure 60 may be interposed between the head chip 51-1 and the flow path structure 52 as in the present embodiment. In the following, the stacking direction of the head chip 51 and the flow path structure 52 may be simply referred to as a stacking direction.

One inlet IH communicates with at least a portion of the plurality of nozzles N formed at the nozzle plate 51c. The nozzle plate 51c of the present embodiment has two nozzle rows La and Lb. Therefore, one inlet IH communicates with a portion of the plurality of nozzles N formed at the nozzle plate 51c, in other words, the plurality of nozzles N constituting the nozzle row La or the plurality of nozzles N constituting the nozzle row Lb. When the number of the nozzle rows formed at the nozzle plate 51c is one, the inlet IH may communicate with all the nozzles N formed at the nozzle plate 51c.

The vibration absorbing body 51d is also referred to as a compliance substrate, is a flexible resin film forming a wall surface of the reservoir R, and absorbs the pressure fluctuation in the ink in the reservoir R. The vibration absorbing body 51d may be a flexible thin plate made of metal. A surface of the vibration absorbing body 51d facing the Z1 direction is joined to the flow path substrate 51a by using an adhesive or the like. On the other hand, a frame body 56 is joined to a surface of the vibration absorbing body 51d facing the Z2 direction by using an adhesive or the like. The frame body 56 is a frame-shaped member along an outer periphery of the vibration absorbing body 51d, and is made of, for example, a metal material. A fixed plate 53, which will be described below, is joined to a surface of the frame body 56 facing the Z1 direction by using an adhesive or the like, as illustrated by a two-dot chain line in the drawing.

The wiring substrate 51i is mounted on the surface of the vibration plate 51e facing the Z1 direction, and is a mounting component for electrically coupling the head chip 51, a drive circuit 51j, and the control unit 20. The wiring substrate 51i is, for example, a flexible wiring substrate such as a chip on film (COF), a flexible printed circuit (FPC) or a flexible flat cable (FFC). The drive circuit 51j is mounted on the wiring substrate 51i of the present embodiment. The drive circuit 51j is a circuit including a switching element for switching, based on a control signal SI, whether or not to supply at least a portion of a waveform included in the drive signal Com to the drive element 51f as a drive pulse.

In the above-described head chip 51, since the drive element 51f is driven by the drive signal Com, the pressure inside the pressure chamber C fluctuates, and the ink is ejected from the nozzle N in accordance with the fluctuation.

### 1-3. Liquid Ejecting Head

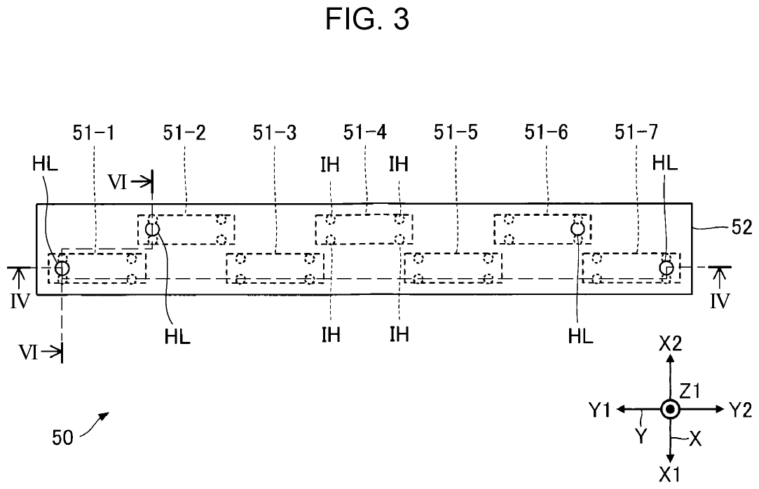

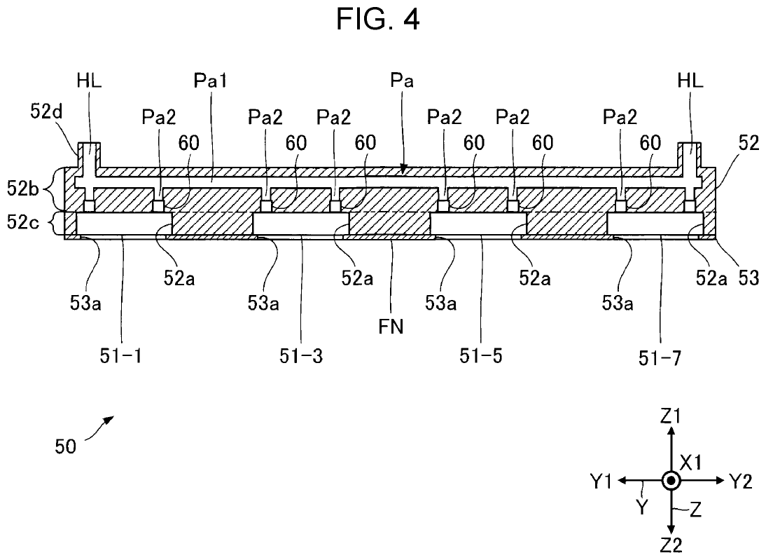

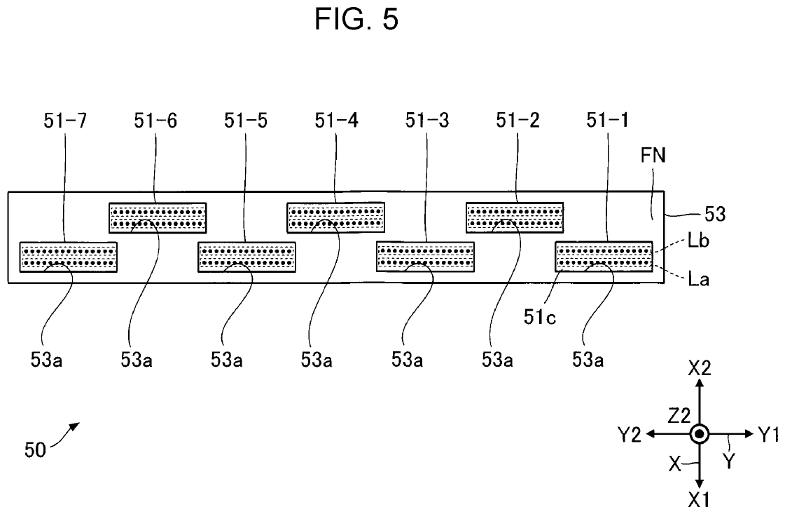

FIG. 3 is a top view of the liquid ejecting head 50 according to the first embodiment. FIG. 4 is a cross-sectional view taken along the line IV-IV in FIG. 3. FIG. 5 is a bottom view of the liquid ejecting head 50 according to the first embodiment. FIGS. 3 to 5 schematically illustrate the liquid ejecting head 50 having head chips 51-1 to 51-7. Each of the head chips 51-1 to 51-7 is the head chip 51 described above. In the following, each of the head chips 51-1 to 51-7 may be referred to as the head chip 51 without distinguishing them.

Here, the head chip 51-1 is an example of a “first head chip”. The relationship between the configuration relating to the head chip 51-1 and the configuration relating to the head chip 51-2 is the same as the relationship of the configuration relating to the other two head chips 51 adjacent to each other in the direction along the X axis among the head chips 51-1 to 51-7.

As illustrated in FIGS. 3 to 5, the liquid ejecting head 50 has the head chips 51-1 to 51-7, the flow path structure 52, the fixed plate 53, and a plurality of the joint structures 60.

As illustrated in FIGS. 3 and 5, the head chips 51-1 to 51-7 are disposed in a staggered pattern when viewed in the direction along the Z axis. Here, the head chips 51-1 to 51-7 are arranged in this order in the Y2 direction. Note that the head chips 51-1, 51-3, 51-5, and 51-7 are disposed so that their positions are aligned with each other in the direction along the X axis. With respect to this, the head chips 51-2, 51-4, and 51-6 are disposed at positions in the X2 direction from the head chips 51-1, 51-3, 51-5, and 51-7 so that their positions are aligned with each other in the direction along the X axis. In addition, two head chips 51 closest to each other among the head chips 51-1 to 51-7 are disposed such that the nozzle rows La and Lb of one head chip 51 and the nozzle rows La and Lb of the other head chip 51 partially overlap when viewed in the direction along the X axis.

The flow path structure 52 is a structure provided with a flow path Pa inside for supplying the ink from the liquid storage portion 10 to the head chips 51-1 to 51-7. For example, the flow path structure 52 is made of a resin material or a metal material.

As illustrated in FIG. 4, the flow path Pa has a common flow path Pa1, a plurality of branch flow paths Pa2, and a plurality of openings HL.

The common flow path Pa1 is a flow path that is commonly provided in the plurality of head chips 51. In the present embodiment, the common flow path Pa1 is configured of a common flow path Pa1-1 commonly provided in the head chips 51-1, 51-3, 51-5, and 51-7, which will be described below, and a common flow path Pa1-2 commonly provided in the head chips 51-2, 51-4, and 51-6, which will be described below. Each of these flow paths extends in a direction intersecting the direction along the Z axis that is the stacking direction, and specifically, extends in the direction along the Y axis. In addition, both ends of each common flow path Pa1 communicate with the opening HL facing the Z1 direction. The ink from the liquid storage portion 10 is introduced into the opening HL.

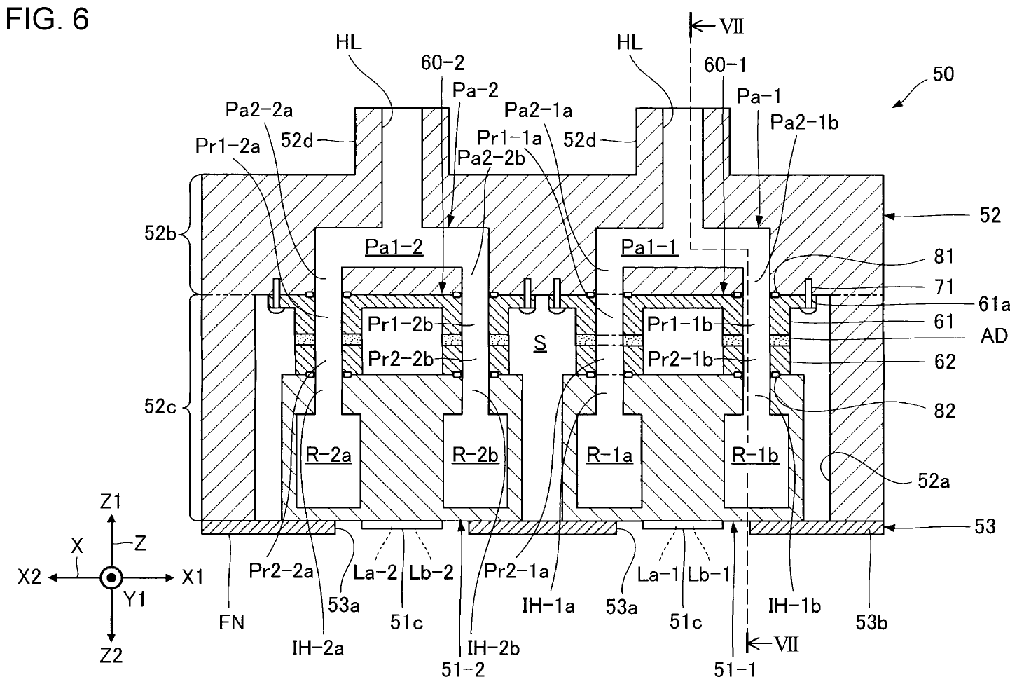

The plurality of branch flow paths Pa2 are respectively provided for the inlets IH of each of the head chips 51-1 to 51-7 and are flow paths that communicate with the common flow path Pa1. In the present embodiment, the plurality of branch flow paths Pa2 includes a plurality of branch flow paths Pa2-1, which will be described below, for supplying the ink to the head chips 51-1, 51-3, 51-5, and 51-7, and a plurality of branch flow paths Pa2-2, which will be described below, for supplying the ink to the head chips 51-2, 51-4, and 51-6. Each of the plurality of branch flow paths Pa2 communicates with the corresponding inlet IH via the joint structure 60. Each of the branch flow paths Pa2 extends in a direction different from the extending direction of the common flow path Pa1, and specifically, extends in the direction along the Z axis, which is the stacking direction. FIG. 4 schematically illustrates the joint structure 60 for the sake of clarity. The configuration of the joint structure 60 will be described below with reference to FIGS. 6 to 8.

The flow path structure 52 of the present embodiment is a holder that accommodates the plurality of head chips 51-1 to 51-7. Accordingly, the flow path structure 52 of the present embodiment has a plurality of recesses 52a that accommodate the plurality of head chips 51. Each of the plurality of recesses 52a is a depression provided on a surface of the flow path structure 52 facing the Z2 direction. The head chip 51 accommodated in such a recess 52a overlaps the flow path structure 52 in the direction along the Z axis. The plurality of recesses 52a may be respectively provided for the head chips 51 or may be respectively provided for groups of two or more head chips 51. Therefore, the number of the recesses 52a does not need to be equal to the number of the head chips 51, the number is not limited to the plural, and may be the singular.

Here, the flow path structure 52 has a flow path forming portion 52b, a wall portion 52c, and a plurality of pipe portions 52d. The flow path Pa is provided in the flow path forming portion 52b. The wall portion 52c protrudes from the flow path forming portion 52b in the Z2 direction so as to form the plurality of recesses 52a using a surface of the flow path forming portion 52b facing the Z2 direction as a bottom surface. The head chip 51 is entirely surrounded by the wall portion 52c when viewed in the Z1 direction. Each of the plurality of pipe portions 52d protrudes from the flow path forming portion 52b in the Z1 direction, and each pipe portion 52d is provided with the opening HL and is coupled with a pipe body (not illustrated) for transporting the ink from the liquid storage portion 10.

The fixed plate 53 is a plate-shaped member for fixing the plurality of head chips 51 to the flow path structure 52. The fixed plate 53 is provided with a plurality of opening portions 53a that expose the nozzle plate 51c of each head chip 51 to the outside of the liquid ejecting head 50. As illustrated in FIG. 2, the opening portion 53a of the present embodiment exposes the entire portion of the nozzle plate 51c to the outside. In other words, an outer periphery of the nozzle plate 51c is disposed within a peripheral edge of the opening portion 53a when viewed in the Z1 direction. However, the opening portion 53a may expose at least a portion of the nozzle plate 51c to the outside. In other words, when viewed in the Z1 direction, an outer peripheral portion of the nozzle plate 51c may be located outside the opening portion 53a, that is, may overlap a flat plate portion 53b that is a plate-shaped portion of the fixed plate 53. In an example illustrated in FIGS. 4 and 5, the plurality of opening portions 53a are individually provided for each head chip 51. For example, the fixed plate 53 is made of a metal material such as stainless steel, titanium, and magnesium alloy.

The surface of the fixed plate 53 facing the Z2 direction described above constitutes a portion of the ejection surface FN together with a portion, which is exposed from the opening portion 53a, on the surface of each head chip 51 facing the Z2 direction.

### 1-4. Joint Structure

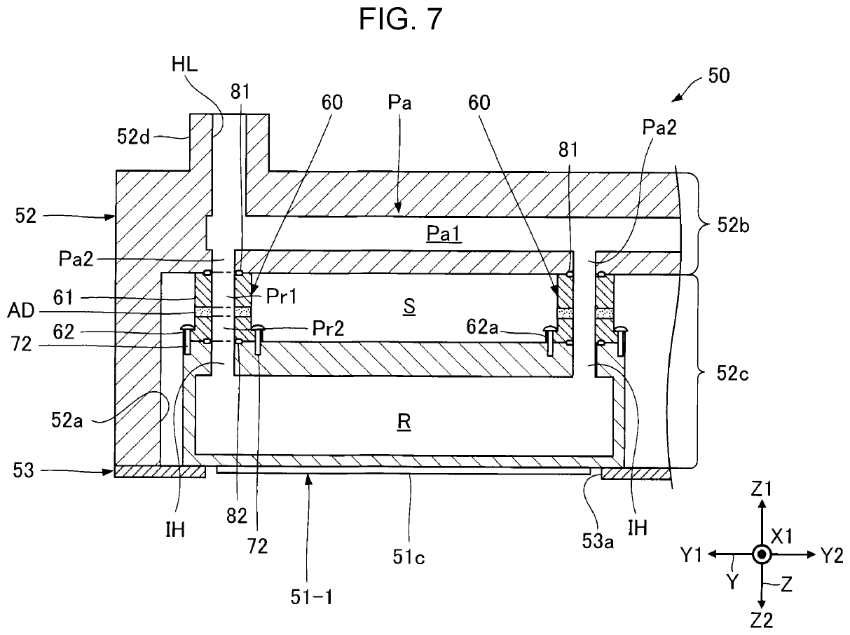

FIG. 6 is a cross-sectional view taken along the line VI-VI in FIG. 3. FIG. 7 is a cross-sectional view taken along the line VII-VII in FIG. 6. FIG. 6 illustrates, among the plurality of joint structures 60, a joint structure 60-1 which is the joint structure 60 corresponding to the head chip 51-1 which is an example of a “first head chip”, and a joint structure 60-2 which is the joint structure 60 corresponding to the head chip 51-2. In the following, each of the joint structure 60-1 and the joint structure 60-2 may be referred to as the joint structure 60 without distinguishing them.

In the following, matters related to the head chips 51-1 and 51-2 will be representatively described, but in the matters described below, the matters related to the head chip 51-1 are the same as those related to the head chips 51-3, 51-5, and 51-7, and the matters related to the head chip 51-2 is the same as those related to the head chips 51-4 and 51-6.

As illustrated in FIG. 6, the head chip 51-1 has a nozzle row La-1, a nozzle row Lb-1, a reservoir R-1a, a reservoir R-1b, an inlet IH-1a, and an inlet IH-1b. The nozzle row La-1 is a nozzle row La of the head chip 51-1. The nozzle row Lb-1 is a nozzle row Lb of the head chip 51-1. The reservoir R-1a is a reservoir R corresponding to the nozzle row La-1. The reservoir R-1b is a reservoir R corresponding to the nozzle row Lb-1. The inlet IH-1a is an inlet IH coupled to the reservoir R-1a. The inlet IH-1b is an inlet IH coupled to the reservoir R-1b.

Here, each of the plurality of nozzles N that constitutes the nozzle row La-1 is an example of a “first nozzle”. The inlet IH-1a is an example of a “second coupling flow path”. The inlet IH-1b is an example of a “fourth coupling flow path”.

Similarly, the head chip 51-2 has a nozzle row La-2, a nozzle row Lb-2, a reservoir R-2a, a reservoir R-2b, an inlet IH-2a, and an inlet IH-2b. The nozzle row La-2 is a nozzle row La of the head chip 51-2. The nozzle row Lb-2 is a nozzle row Lb of the head chip 51-2. The reservoir R-2a is a reservoir R corresponding to the nozzle row La-2. The reservoir R-2b is a reservoir R corresponding to the nozzle row Lb-2. The inlet IH-2a is an inlet IH coupled to the reservoir R-2a. The inlet IH-2b is an inlet IH coupled to the reservoir R-2b.

On the other hand, the flow path structure 52 has a flow path Pa-1 and a flow path Pa-2. The flow path Pa-1 is a flow path Pa for supplying the ink to the reservoirs R-1a and R-1b. The flow path Pa-1 has a common flow path Pa1-1, a branch flow path Pa2-1a, and a branch flow path Pa2-1b. The common flow path Pa1-1 is a common flow path Pa1 for supplying the ink to the reservoirs R-1a and R-1b. The branch flow path Pa2-1a is a branch flow path Pa2 for supplying the ink to the reservoir R-1a. The branch flow path Pa2-1b is a branch flow path Pa2 for supplying the ink to the reservoir R-1b.

Here, the branch flow path Pa2-1a is an example of a “first coupling flow path”. The branch flow path Pa2-1b is an example of a “third coupling flow path”.

Similarly, the flow path Pa-2 is a flow path Pa different from the flow path Pa-1 and is a flow path Pa for supplying the ink to the reservoirs R-2a and R-2b. The flow path Pa-2 has a common flow path Pa1-2, a branch flow path Pa2-2a, and a branch flow path Pa2-2b. The common flow path Pa1-2 is a common flow path Pa1 for supplying the ink to the reservoirs R-2a and R-2b. The branch flow path Pa2-2a is a branch flow path Pa2 for supplying the ink to the reservoir R-2a. The branch flow path Pa2-2b is a branch flow path Pa2 for supplying the ink to the reservoir R-2b.

In the following, each of the flow path Pa-1 and the flow path Pa-2 may be referred to as the flow path Pa without distinguishing them. Each of the common flow path Pa1-1 and the common flow path Pa1-2 may be referred to as the common flow path Pa1 without distinguishing them. Each of the branch flow path Pa2-1a and the branch flow path Pa2-1b may be referred to as the branch flow path Pa2-1 without distinguishing them. Each of the branch flow path Pa2-2a and the branch flow path Pa2-2b may be referred to as the branch flow path Pa2-2 without distinguishing them. Each of the branch flow path Pa2-1 and the branch flow path Pa2-2 may be referred to as the branch flow path Pa2 without distinguishing them.

As illustrated in FIGS. 6 and 7, the flow path structure 52 described above is coupled to the head chip 51-1 via two joint structures 60-1 in the space S formed by the recess 52a, and is coupled to the head chip 51-2 via two joint structures 60-2. The joint structure 60 of the present embodiment is detachably fixed to each of the flow path structure 52 and the head chip 51.

The joint structure 60 is a structure for communicating the flow path Pa of the flow path structure 52 with the reservoir R of the head chip 51. The joint structure 60 in the present embodiment has one first joint member 61, two second joint members 62, an adhesive AD, a plurality of fixing members 71, a plurality of fixing members 72, and a plurality of sealing members 81, and a plurality of sealing members 82.

A first joint member 61 of the joint structure 60-1 has a relay flow path Pr1-1a and a relay flow path Pr1-1b. Each of the relay flow path Pr1-1a and the relay flow path Pr1-1b is open to each of an end in the Z1 direction and an end in the Z2 direction of the first joint member 61. Here, the relay flow path Pr1-1a is an example of a “first relay flow path”. The relay flow path Pr1-1b is an example of a “third relay flow path”.

Similarly, a first joint member 61 of the joint structure 60-2 has a relay flow path Pr1-2a and a relay flow path Pr1-2b. Each of the relay flow path Pr1-2a and the relay flow path Pr1-2b is open to each of the end in the Z1 direction and the end in the Z2 direction of the first joint member 61.

In the following, each of the relay flow path Pr1-1a and the relay flow path Pr1-1b may be referred to as the relay flow path Pr1-1 without distinguishing them. Each of the relay flow path Pr1-2a and the relay flow path Pr1-2b may be referred to as the relay flow path Pr1-2 without distinguishing them. Each of the relay flow path Pr1-1 and the relay flow path Pr1-2 may be referred to as the relay flow path Pr1 without distinguishing them. The relay flow path Pr1 extends along the Z axis.

At the end of the first joint member 61 in the Z1 direction, a flange 61a is provided in the direction along the Z axis, which is considered as a plate thickness direction, and the flange 61a is fixed to a surface of the flow path forming portion 52b of the flow path structure 52 facing the Z2 direction by screwing using screws which are a plurality of fixing members 71. Accordingly, the first joint member 61 is detachably fixed to the flow path structure 52. “detachably fixed” means that two target members are fixed so as not to change the positional relationship between two target members without using adhesion or welding.

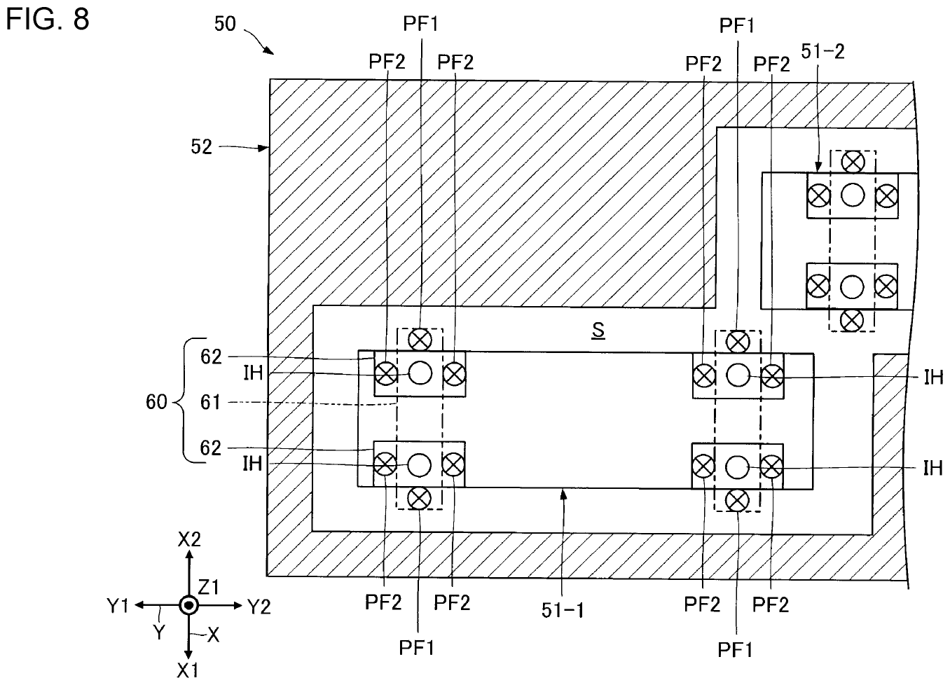

Each of the plurality of fixing members 71 is a screw formed with a male screw that penetrates the flange 61a and is screwed into a female screw formed in a screw hole provided in the flow path structure 52. Accordingly, each of the plurality of fixing members 71 detachably fixes the first joint member 61 to the flow path structure 52. Here, each fixing member 71 tightens the first joint member 61 and the flow path structure 52 together so as to compress the sealing member 81. The disposition of each fixing member 71 will be described below with reference to FIG. 8. The flange 61a may be provided as needed and may be omitted.

The elastic sealing member 81 is disposed between the first joint member 61 and the flow path structure 52. The “elasticity” refers to the property of being elastically deformable. The sealing member 81 is made of, for example, an elastic material such as an elastomer. Examples of the elastomer include a thermosetting elastomer and a thermoplastic elastomer. Examples of the thermosetting elastomer include vulcanized rubber and a thermosetting resin-based elastomer such as silicone rubber or fluororubber. The sealing member 81 is disposed in an elastically deformed state by being interposed between the first joint member 61 and the flow path structure 52. Accordingly, the first joint member 61 and the flow path structure 52 are liquid-tightly coupled to each other via the sealing member 81.

In the examples illustrated in FIGS. 6 and 7, the sealing member 81 is a ring-shaped member. The sealing member 81 may be configured separately from the flow path structure 52 and the first joint member 61, or may be configured integrally with the flow path structure 52 or the first joint member 61 by insert molding or the like. It is preferable that the sealing member 81 is integrally configured with the first joint member 61. Although details will be described below, when the liquid ejecting head 50 is regenerated by replacing the head chip 51 or the head chip 51 is reused as a portion of another liquid ejecting head 50, it is possible to improve the sealing member 81 can be easily replaced, and the reliability of the liquid-tightness between the branch flow path Pa2 and the relay flow path Pr1 by the sealing member 81. The shape of the sealing member 81 is not limited to the examples illustrated in FIGS. 6 and 7, and may be, for example, a sheet shape having holes constituting the flow path. In addition, the sealing member 81 is not limited to an aspect in which the sealing member 81 is individually provided for each inlet IH, and may also be integrally provided for two or more inlets IH in common.

In this way, the first joint member 61 is detachably fixed to the flow path structure 52, so that the branch flow path Pa2-1a and the relay flow path Pr1-1a are coupled to each other, and the branch flow path Pa2-1b and the relay flow path Pr1-1b are coupled to each other. Similarly, the branch flow path Pa2-2a and the relay flow path Pr1-2a are coupled to each other, and the branch flow path Pa2-2b and the relay flow path Pr1-2b are coupled to each other. In the present specification, for two target spaces, “coupling” means an aspect in which two target spaces are directly coupled to each other.

Two second joint members 62 of the joint structure 60-1 have a relay flow path Pr2-1a and a relay flow path Pr2-1b. Each of the relay flow path Pr2-1a and the relay flow path Pr2-1b is open to each of an end in the Z1 direction and an end in the Z2 direction of the two second joint members 62. Here, the relay flow path Pr2-1a is an example of a “second relay flow path”.

Similarly, two second joint members 62 of the joint structure 60-2 have a relay flow path Pr2-2a and a relay flow path Pr2-2b. Each of the relay flow path Pr2-2a and the relay flow path Pr2-2b is open to each of an end in the Z1 direction and an end in the Z2 direction of the two second joint members 62.

In the following, each of the relay flow path Pr2-1a and the relay flow path Pr2-1b may be referred to as the relay flow path Pr2-1 without distinguishing them. Each of the relay flow path Pr2-2a and the relay flow path Pr2-2b may be referred to as the relay flow path Pr2-2 without distinguishing them. Each of the relay flow path Pr2-1 and the relay flow path Pr2-2 may be referred to as the relay flow path Pr2 without distinguishing them. The relay flow path Pr2 extends along the Z axis.

The end of the second joint member 62 in the Z1 direction is joined to the end of the first joint member 61 in the Z2 direction by using an adhesive AD. Such an adhesive AD is disposed around the opening of the relay flow path Pr2-1a toward the branch flow path Pa2-1a, and is disposed around the opening of the relay flow path Pr2-1b toward the branch flow path Pa2-1b. That is, when viewed in plan view, the adhesive AD surrounds the opening of the relay flow path Pr1 and the opening of the relay flow path Pr2 facing each other over the entire circumference. Accordingly, the relay flow path Pr1-1a and the relay flow path Pr2-1a are liquid-tightly coupled to each other, and the relay flow path Pr1-1b and the relay flow path Pr2-1b are liquid-tightly coupled to each other. Similarly, by using the adhesive AD, the relay flow path Pr1-2a and the relay flow path Pr2-2a are liquid-tightly coupled to each other, and the relay flow path Pr1-2b and the relay flow path Pr2-2b are liquid-tightly coupled to each other.

The adhesive AD is not particularly limited as long as the adhesive AD has resistance to an ink and can liquid-tightly join the first joint member 61 and the second joint member 62 to each other, but is preferably a thermosetting adhesive such as an epoxy-based thermosetting adhesive from the viewpoint of having excellent both joint strength and liquid resistance.

In addition, at an end of the second joint member 62 in the Z2 direction, a flange 62a is provided in the direction along the Z axis, which is considered as a plate thickness direction, and the flange 62a is fixed to a surface of the head chip 51 facing the Z1 direction by screwing using screws which are a plurality of fixing members 72. Accordingly, the second joint member 62 is detachably fixed to the head chip 51.

Each of the plurality of fixing members 72 is a screw formed with a male screw that penetrates the flange 62a and is screwed into a female screw formed in a screw hole provided in the head chip 51. Accordingly, each of the plurality of fixing members 72 detachably fixes the second joint member 62 to the head chip 51. Here, each fixing member 72 tightens the second joint member 62 and the head chip 51 together so as to compress the sealing member 82. The disposition of each fixing member 72 will be described below with reference to FIG. 8. The flange 62a may be provided as needed and may be omitted.

The elastic sealing member 82 is disposed between the second joint member 62 and the head chip 51. The sealing member 82 is made of the same elastic material as the sealing member 81. The sealing member 82 is disposed in an elastically deformed state by being interposed between the second joint member 62 and the head chip 51. Accordingly, the second joint member 62 and the head chip 51 are liquid-tightly coupled to each other via the sealing member 82.

In the examples illustrated in FIGS. 6 and 7, the sealing member 82 is a ring-shaped member. The sealing member 82 may be configured separately from the head chip 51 and the second joint member 62, or may be configured integrally with the head chip 51 or the second joint member 62 by insert molding or the like. Note that it is preferable that the sealing member 82 is integrally configured with the second joint member 62. Although details will be described below, when the liquid ejecting head 50 is regenerated by replacing the head chip 51 or the head chip 51 is reused as a portion of another liquid ejecting head 50, it is possible to improve the sealing member 82 can be easily replaced, and the reliability of the liquid-tightness between the inlet IH and the relay flow path Pr2 by the sealing member 82. The shape of the sealing member 82 is not limited to the examples illustrated in FIGS. 6 and 7, and may be, for example, a sheet shape having holes constituting the flow path. In addition, the sealing member 82 is not limited to an aspect in which the sealing member 82 is individually provided for each inlet IH, and may also be integrally provided for two or more inlets IH in common.

In this way, the two second joint members 62 of the joint structure 60-1 are detachably fixed to the head chip 51, so that the inlet IH-1a and the relay flow path Pr2-1a are coupled to each other, and the inlet IH-1b and the relay flow path Pr2-1b are coupled to each other. Similarly, the two second joint members 62 of the joint structure 60-2 are detachably fixed to the head chip 51, so that the inlet IH-2a and the relay flow path Pr2-2a are coupled to each other, and the inlet IH-2b and the relay flow path Pr2-2b are coupled to each other.

As described above, the head chip 51-1 is coupled to the flow path structure 52 via the two joint structures 60-1, so that the branch flow path Pa2-1a communicates with the inlet IH-1a via the relay flow paths Pr1-1a and Pr2-1a and the branch flow path Pa2-1b communicates with the inlet IH-1b via the relay flow paths Pr1-1b and Pr2-1b. Similarly, the head chip 51-2 is coupled to the flow path structure 52 via the two joint structures 60-2, so that the branch flow path Pa2-2a communicates with the inlet IH-2a via the relay flow paths Pr1-2a and Pr2-2a and the branch flow path Pa2-2b communicates with the inlet IH-2b via the relay flow paths Pr1-2b and Pr2-2b. Therefore, the ink flows in the flow path composed of the branch flow path Pa2, the relay flow path Pr1, the relay flow path Pr2, and the inlet IH along the Z-axis direction, which is the stacking direction.

FIG. 8 is a schematic plan view for describing a first fixing position PF1 and a second fixing position PF2 according to the first embodiment. FIG. 8 schematically illustrates a relationship between the head chip 51 and the first fixing position PF1 and the second fixing position PF2 when viewed in the Z2 direction.

The first fixing position PF1 is a position for detachably fixing the first joint member 61 to the flow path structure 52. More specifically, the first fixing position PF1 is a position where a force that fixes the flow path structure 52 and the first joint member 61 to each other is applied. In the present embodiment, since the flow path structure 52 and the first joint member 61 are fixed to each other by screwing using the fixing member 71, the first fixing position PF1 is a position of the fixing member 71.

On the other hand, the second fixing position PF2 is a position for detachably fixing the second joint member 62 to the head chip 51. More specifically, the second fixing position PF2 is a position where a force that fixes the head chip 51 and the second joint member 62 to each other is applied. In the present embodiment, since the head chip 51 and the second joint member 62 are fixed to each other by screwing using the fixing member 72, the second fixing position PF2 is a position of the fixing member 72.

As described in the fourth to eighth embodiments which will be described below, the method for fixing the first joint member 61 to the flow path structure 52 is not limited to screwing. Here, the “first fixing position PF1” is, for example, a position such as a position of a spring when the flow path structure 52 and the first joint member 61 are fixed to each other by a spring force, or a position of a claw when the flow path structure 52 and the first joint member 61 are fixed to each other by a restricting force of the claw. Similarly, the “second fixing position PF2” is, for example, a position such as a position of a spring when the head chip 51 and the second joint member 62 are fixed to each other by a spring force, or a position of a claw when the head chip 51 and the second joint member 62 are fixed to each other by a restricting force of the claw.

As illustrated in FIG. 8, each of the first joint members 61 has a shape extending in the direction along the X axis when viewed in the direction along the Z axis. A width of each first joint member 61 along the X axis is larger than a width of the head chip 51 along the X axis. Then, an end of the first joint member 61 in the X1 direction is disposed in the X1 direction from the head chip 51 and an end of the first joint member 61 in the X2 direction is disposed in the X2 direction from the head chip 51. Accordingly, the first joint member 61 has two portions that do not overlap the head chip 51 when viewed in the direction along the Z axis. The first fixing position PF1 is located at each of the two portions. The two portions are at least a portion of the flange 61a described above. The shape of the first joint member 61 when viewed in the direction along the Z axis is not limited to the example illustrated in FIG. 8, and is set in any desired way.

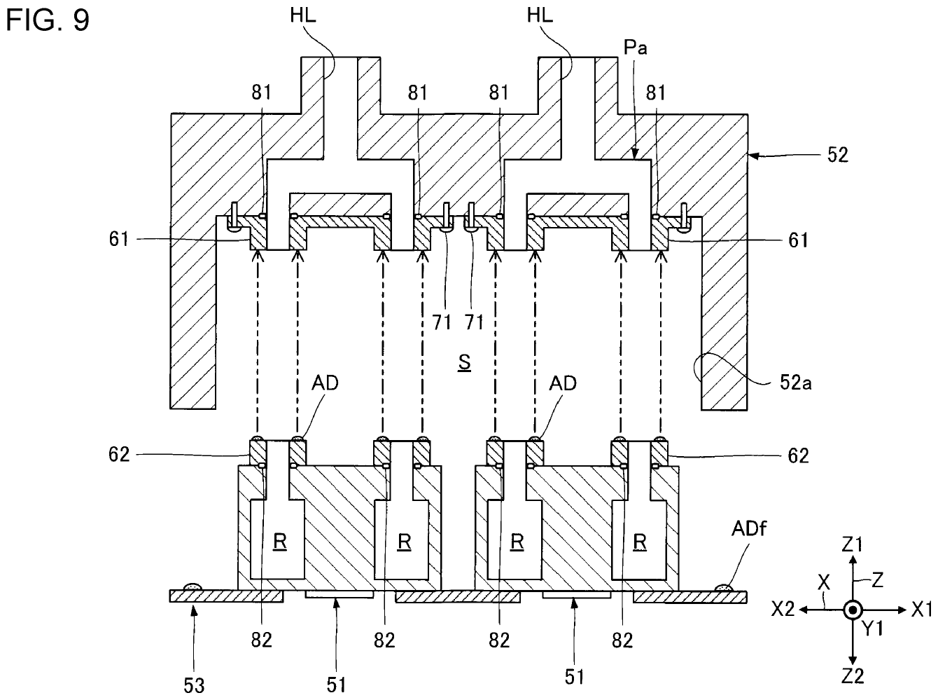

In this way, the first fixing position PF1 does not overlap the head chip 51-1 when viewed in the stacking direction of the head chip 51-1 and the flow path structure 52. For this reason, access to the first fixing position PF1 becomes possible without detaching the head chip 51-1. Therefore, as illustrated in FIG. 9 which will be described below, there is an advantage that when detaching the head chip 51-1 from the flow path structure 52, it is not necessary to apply a stress to the head chip 51-1 to be detached.

In contrast, each of the second joint members 62 has a shape extending in the direction along the Y axis when viewed in the direction along the Z axis. A width of each second joint member 62 along the Y axis is larger than a width of the above-described first joint member 61 along the Y axis. Then, an end of the second joint member 62 in the Y1 direction is disposed in the Y1 direction from the first joint member 61 and an end of the second joint member 62 in the Y2 direction is disposed in the Y2 direction from the first joint member 61. Accordingly, the second joint member 62 has two portions that do not overlap the first joint member 61 when viewed in the direction along the Z axis. The second fixing position PF2 is located at each of the two portions. The two portions are at least a portion of the flange 62a described above. In addition, the two portions overlap the head chip 51 when viewed in the direction along the Z axis. The shape of the second joint member 62 when viewed in the direction along the Z axis is not limited to the example illustrated in FIG. 8, and is set in any desired way.

In this way, when viewed in the stacking direction of the head chip 51-1 and the flow path structure 52, the second fixing position PF2 overlaps the head chip 51 without overlapping the first joint member 61. Since the second fixing position PF2 overlaps the head chip 51 when viewed in the direction along the Z axis, the second joint member 62 can be fixed to the head chip 51-1. In addition, since the second fixing position PF2 does not overlap the first joint member 61 when viewed in the direction along the Z axis, after detaching the head chip 51-1 from the flow path structure 52 as a unit for the first joint member 61 and the second joint member 62, access to the second fixing position PF2 becomes possible without failure of the adhesive AD. Therefore, it is possible to detach the second joint member 62 from the head chip 51-1 without failure of the adhesive AD.

### 1-5. Manufacturing of New Liquid Ejecting Head

FIG. 9 is a view for describing an assembly of the liquid ejecting head 50 according to the first embodiment. When manufacturing a new liquid ejecting head 50, as illustrated in FIG. 9, first, the first joint member 61 is detachably fixed to the flow path structure 52 by the fixing member 71, and the second joint member 62 is detachably fixed to the head chip 51 by the fixing member 72. In that state, thereafter, the first joint member 61 and the second joint member 62 are bonded with the adhesive AD. In the example illustrated in FIG. 9, the adhesive AD before curing is applied to the second joint member 62. The adhesive AD before curing may be applied to the first joint member 61.

Here, in a state in which the plurality of head chips 51 aligned with each other are bonded to the fixed plate 53, the first joint member 61 and the second joint member 62 are bonded with the adhesive AD. In addition, at this time, an adhesive ADf before curing is applied to the fixed plate 53 for bonding to the flow path structure 52. The adhesive ADf before curing may be applied to the flow path structure 52.

As described above, since the first joint member 61 and the second joint member 62 are bonded with the adhesive AD in a state in which the plurality of head chips 51 are aligned, each head chip 51 is positioned with high accuracy. At the same time, the flow path structure 52 and the head chip 51 can be coupled via the first joint member 61 and the second joint member 62 while reducing the application of unnecessary stress to the fixed plate 53. In this way, by using the adhesive AD, it is possible to suppress the alignment deviation between the head chips 51 bonded to the fixed plate 53.

In contrast, in an aspect in which the liquid ejecting head 50 does not include the joint structure 60, for example, by interposing an elastic sealing member between the head chip 51 and the flow path structure 52 in the direction along the Z axis, the inlet IH and the branch flow path Pa2 are liquid-tightly coupled. There is a risk that the head chip 51 or the fixed plate 53 may be deformed by the reaction force of the sealing member, resulting in misalignment.

### 1-6. Reuse of Head Chip and Regenerating of Liquid Ejecting Head

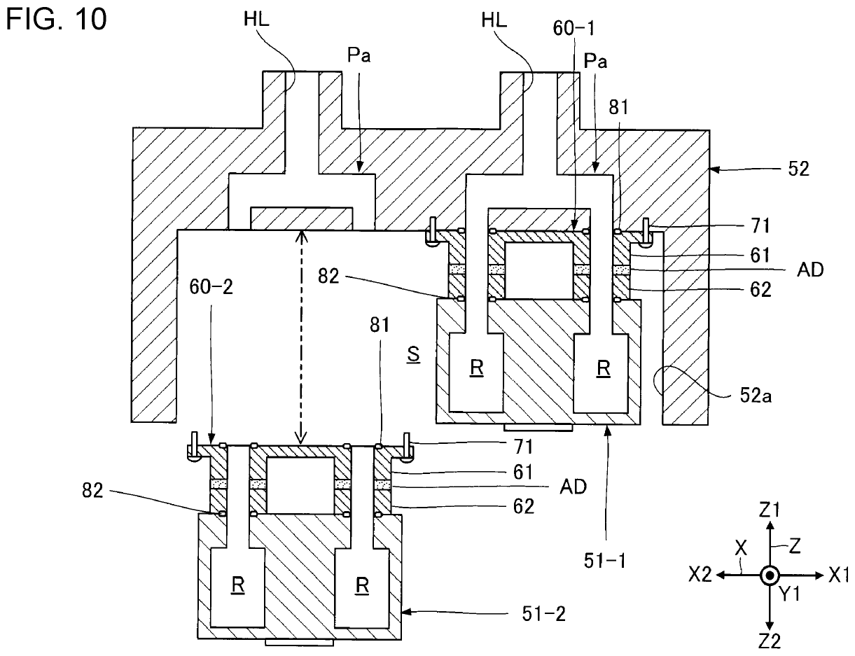

FIG. 10 is a view for describing detachment of the head chip 51 from the liquid ejecting head 50 according to the first embodiment. FIG. 10 illustrates a case of detaching the head chip 51-2. For example, when the head chip 51-1 does not fail and the head chip 51-2 is reused as another liquid ejecting head 50, or when the head chip 51-2 fails and the liquid ejecting head 50 from which the head chip 51-2 is detached is regenerated, the head chip 51-2 is detached. When it is determined that the life of the head chip 51-2 is short, such as when the number of times of ink ejection from the nozzle N exceeds a threshold value, the head chip 51-2 may be detached from the flow path structure 52 in consideration of a failure.

As illustrated in FIG. 10, the head chip 51-2 is detached from the liquid ejecting head 50 by releasing the fastening state by the fixing member 71 using a tool such as a screwdriver. At this time, the bonding state by the adhesive AD and the fastening state by the fixing member 72 are maintained, but as described above, the fixing member 71 is disposed at a position not overlapping the head chip 51 when viewed in the direction along the Z axis. Therefore, access of the tool to the fixing member 71 is possible.

The fixed plate 53 is detached by an appropriate method before detaching the head chip 51-2 from the liquid ejecting head 50. The fixed plate 53 is detached, for example, by disassembling or melting an adhesive that bonds the head chip 51 and the fixed plate 53 to each other using an appropriate method.

In this way, the head chip 51-2 can be detached along with the joint structure 60-2. Here, by using the joint structure 60, there is no adhesive residue in each of the head chip 51 and the flow path structure 52. Therefore, when the head chip 51 is reused and the liquid ejecting head 50 is regenerated which will be described below, the inlet IH of the head chip 51 and the branch flow path Pa2 of the flow path structure 52 are easily recoupled.

In contrast, in the related art, the head chip 51 and the flow path structure 52 are directly coupled to each other with an adhesive. Thus, there is a risk that when the head chip 51 and the flow path structure 52 are forcibly separated, adhesive residue is generated in these, and a portion of the head chip 51 forming the inlet IH to which the adhesive is applied or a portion of the flow path structure 52 forming the branch flow path Pa2 to which the adhesive is applied is damaged. For this reason, it is difficult to recouple the inlet IH of the head chip 51 and the branch flow path Pa2 of the flow path structure 52.

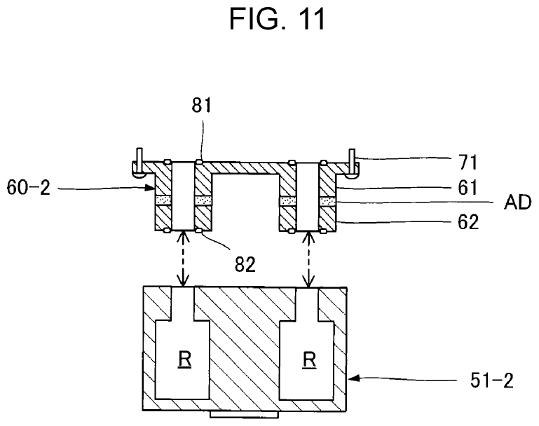

FIG. 11 is a view for describing reusing of the head chip 51-2 in the first embodiment. When the detached head chip 51-2 does not fail as illustrated in FIG. 10, which will be described below, and can be reused, the joint structure 60-2 is detached from the head chip 51-2 by releasing the fastening state by the fixing member 72 using a tool such as a screwdriver as illustrated in FIG. 11. At this time, although the bonding state by the adhesive AD is maintained, the fixing member 72 is disposed at a position that does not overlap the first joint member 61 when viewed in the direction along the Z axis as described above, so that access to the fixing member 72 becomes possible with the tool.

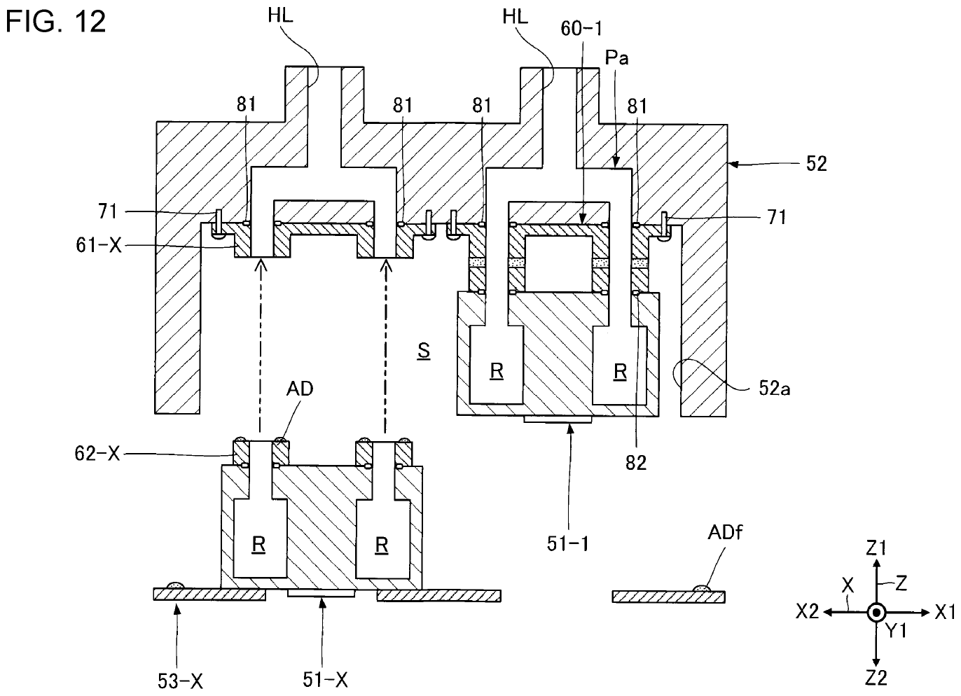

The head chip 51-2 detached in this way is used for the head chip 51 used for manufacturing of the new liquid ejecting head 50 illustrated in FIG. 9 described above, or used for the head chip 51 used for regenerating the liquid ejecting head 50 illustrated in FIG. 12 which will be described below.

In this way, there is no adhesive residue on the head chip 51-2. Therefore, when the head chip 51-2 is reused, the inlet IH of the head chip 51-2 and the branch flow path Pa2 of the flow path structure 52 are easily recoupled.

FIG. 12 is a view for describing regenerating of the liquid ejecting head 50 in the first embodiment. When the liquid ejecting head 50 after the head chip 51-2 is detached as illustrated in FIG. 10 can be regenerated, first, as illustrated in FIG. 12, a new first joint member 61-X compatible with the first joint member 61 is fixed to the flow path structure 52, and a new second joint member 62-X compatible with the second joint member 62 is fixed to a new head chip 51-X compatible with the head chip 51. In that state, thereafter, the first joint member 61-X and the second joint member 62-X are bonded with the adhesive AD. In the example illustrated in FIG. 12, the adhesive AD before curing is applied to the second joint member 62-X. The adhesive AD before curing may be applied to the first joint member 61-X.

Here, in a state in which the head chip 51-X is bonded to a fixed plate 53-X compatible with the fixed plate 53, the first joint member 61-X and the second joint member 62-X are bonded with the adhesive AD. In addition, at this time, an adhesive ADf before curing is applied to the fixed plate 53-X for bonding to the flow path structure 52. In addition, although not illustrated, an adhesive before curing is applied to the fixed plate 53-X for bonding to another head chip 51. The adhesive ADf before curing may be applied to the flow path structure 52. In addition, as illustrated in FIG. 10, when the fixed plate 53 after the head chip 51-2 is detached can be reused, the fixed plate 53 may be used instead of the fixed plate 53-X. Further, the fixed plate 53 may be bonded to the plurality of head chips 51 including the head chip 51-X after bonding the first joint member 61-X and the second joint member 62-X with the adhesive AD.

As described above, it is possible to regenerate the liquid ejecting head 50 after the head chip 51-2 is detached. Here, there is no adhesive residue in the flow path structure 52. Therefore, when regenerating the liquid ejecting head 50, it is possible to easily recouple the inlet IH of the head chip 51 and the branch flow path Pa2 of the flow path structure 52.

As described above, the liquid ejecting head 50 includes the flow path structure 52, the head chip 51-1 which is an example of a “first head chip”, and the first joint member 61. The flow path structure 52 has a branch flow path Pa2-1a, which is an example of a “first coupling flow path”. The head chip 51-1 has the plurality of nozzles N constituting the nozzle row La-1 and the inlet IH-1a which is an example of a “second coupling flow path”. Each of the plurality of nozzles N constituting the nozzle row La-1 ejects an ink, which is an example of a “liquid”. The inlet IH-1a communicates with the plurality of nozzles N constituting the nozzle row La-1. The first joint member 61 has the relay flow path Pr1-1a, which is an example of a “first relay flow path”. The relay flow path Pr1-1a communicates with the branch flow path Pa2-1a and the inlet IH-1a.

Here, the first joint member 61 is detachably fixed to the flow path structure 52, so that the branch flow path Pa2-1a and the relay flow path Pr1-1a are coupled to each other. In addition, the adhesive AD is disposed around the opening of the relay flow path Pr1-1a facing the inlet IH-1a, so that the inlet IH-1a and the relay flow path Pr1-1a liquid-tightly communicate with each other.

In the liquid ejecting head 50 described above, since the first joint member 61 is detachably fixed to the flow path structure 52, it is possible to detach the head chip 51-1 from the flow path structure 52 together with the first joint member 61. Therefore, it is possible to regenerate the liquid ejecting head 50 by replacing the detached head chip 51-1 with another head chip 51. In addition, it is also possible to reuse the detached head chip 51-1 as a portion of another liquid ejecting head 50.

In addition, since the inlet IH-1a and the relay flow path Pr1-1a liquid-tightly communicate with each using the adhesive AD, at the time of manufacturing or regenerating the liquid ejecting head 50, bonding using the adhesive AD can be performed after the first joint member 61 is attached to the flow path structure 52. Therefore, by performing the bonding while aligning the head chip 51-1, the head chip 51-1 can be easily mounted on the liquid ejecting head 50.

In the present embodiment, as described above, the first fixing position PF1 for detachably fixing the first joint member 61 to the flow path structure 52 does not overlap the head chip 51-1 when viewed in the stacking direction of the head chip 51-1 and the flow path structure 52. For this reason, access to the first fixing position PF1 becomes possible without detaching the head chip 51-1. Therefore, there is an advantage that when detaching the head chip 51-1 from the flow path structure 52, it is not necessary to apply a stress to the head chip 51-1 to be detached.

In addition, as described above, the liquid ejecting head 50 further includes the second joint member 62 having the relay flow path Pr2-1a, which is an example of a “second relay flow path”. The relay flow path Pr2-1a communicates with the branch flow path Pa2-1a and communicates with the inlet IH-1a via the relay flow path Pr1-1a. Here, the second joint member 62 is detachably fixed to the head chip 51-1, so that the inlet IH-1a and the relay flow path Pr2-1a are coupled to each other. In addition, the adhesive AD is disposed around the opening of the relay flow path Pr2-1a toward the branch flow path Pa2-1a, so that the relay flow path Pr1-1a and the relay flow path Pr2-1a are liquid-tightly coupled to each other. By using such a second joint member 62, both the regenerating of the liquid ejecting head 50 by replacing the head chip 51 and the reuse of the head chip 51 become possible.

Moreover, the second fixing position PF2 for detachably fixing the second joint member 62 to the head chip 51-1 does not overlap the first joint member 61 when viewed in the stacking direction of the head chip 51-1 and the flow path structure 52. Therefore, after the head chip 51-1 is detached from the flow path structure 52 as a unit for the first joint member 61 and the second joint member 62, the second joint member 62 can be detached from the head chip 51-1 without failure of the adhesive AD. As a result, it is possible to reuse the head chip 51-1 as a portion of another liquid ejecting head 50.

Here, the second joint member 62 is detachably fixed to the head chip 51-1 so that the inlet IH-1a and the relay flow path Pr2-1a are coupled to each other, and since the adhesive AD is disposed around the opening of the relay flow path Pr2-1a toward the branch flow path Pa2-1a, the relay flow path Pr1-1a and the relay flow path Pr2-1a are liquid-tightly coupled to each other. Accordingly, the head chip 51-1 can be detached in a state where there is no remaining adhesive AD by detaching the second joint member 62 from the head chip 51-1. Therefore, it is possible to suitably perform reuse of the head chip 51-1.

Further, as described above, when the adhesive AD is a thermosetting adhesive, the liquid resistance of the adhesive AD can be improved. Here, since the thermosetting adhesive after curing is not melted by heating, it cannot be removed by heating. However, in the present disclosure, since it is not necessary to remove the adhesive AD, by using such an adhesive AD, it is possible to improve the liquid resistance of the adhesive AD while making at least one of the head chip 51 and the flow path structure 52 replaceable.

In addition, as described above, the liquid ejecting head 50 further includes the elastic sealing member 81. The sealing member 81 is interposed between the first joint member 61 and the flow path structure 52 to liquid-tightly couple the branch flow path Pa2-1a and the relay flow path Pr1-1a. Therefore, even when the first joint member 61 is detachable from the flow path structure 52, the branch flow path Pa2-1a and the relay flow path Pr1-1a can be liquid-tightly coupled to each other.

Further, as described above, the liquid ejecting head 50 further includes the fixing member 71 that detachably fixes the first joint member 61 to the flow path structure 52. Therefore, it is possible to detachably fix the first joint member 61 to the flow path structure 52.

Here, as described above, the fixing member 71 is a screw that tightens the first joint member 61 and the flow path structure 52 together so as to compress the sealing member 81. Therefore, the branch flow path Pa2-1a and the relay flow path Pr1-1a can be liquid-tightly coupled to each other. In addition, when the fixing member 71 is a screw, the first joint member 61 can be easily attached to and detached from the flow path structure 52 by using a tool such as a screwdriver.

In addition, as described above, the flow path structure 52 further has the branch flow path Pa2-1b, which is an example of a “third coupling flow path”. The branch flow path Pa2-1b is a flow path different from the branch flow path Pa2-1a. On the other hand, the head chip 51-1 further has the inlet IH-1b, which is an example of a “fourth coupling flow path”. The inlet IH-1b is a flow path that communicates with the branch flow path Pa2-1b and that is different from the inlet IH-1a. In addition, the first joint member 61 further has the relay flow path Pr1-1b, which is an example of a “third relay flow path”. The relay flow path Pr1-1b communicates with the branch flow path Pa2-1b and the inlet IH-1b.

Here, the adhesive AD is disposed around the opening of the relay flow path Pr1-1b facing the inlet IH-1b, so that the inlet IH-1b and the relay flow path Pr1-1b liquid-tightly communicate with each other. Therefore, one first joint member 61 can be shared with a plurality of flow paths of one head chip 51. As a result, when one head chip 51 has a plurality of flow paths, the first joint member 61 can be easily detached from the flow path structure 52.

### 2. SECOND EMBODIMENT

In the following, a second embodiment of the present disclosure will be described. In each embodiment exemplified in the following, for elements whose actions and functions are similar to those of the first embodiment, the reference numerals used in the explanation of the first embodiment are used and detailed explanation of each is appropriately omitted.

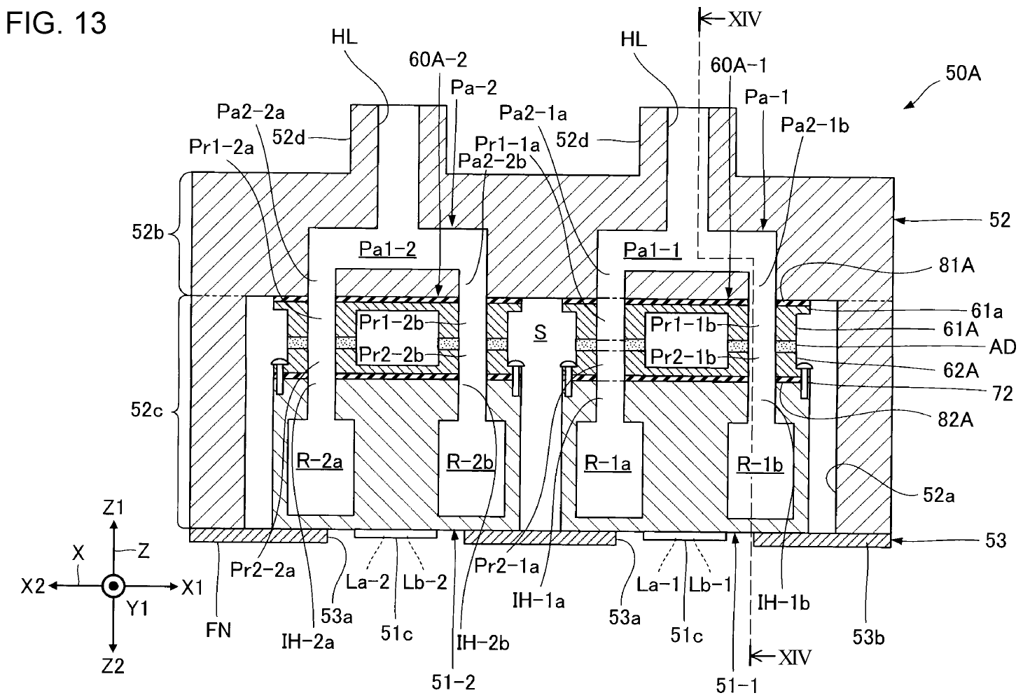

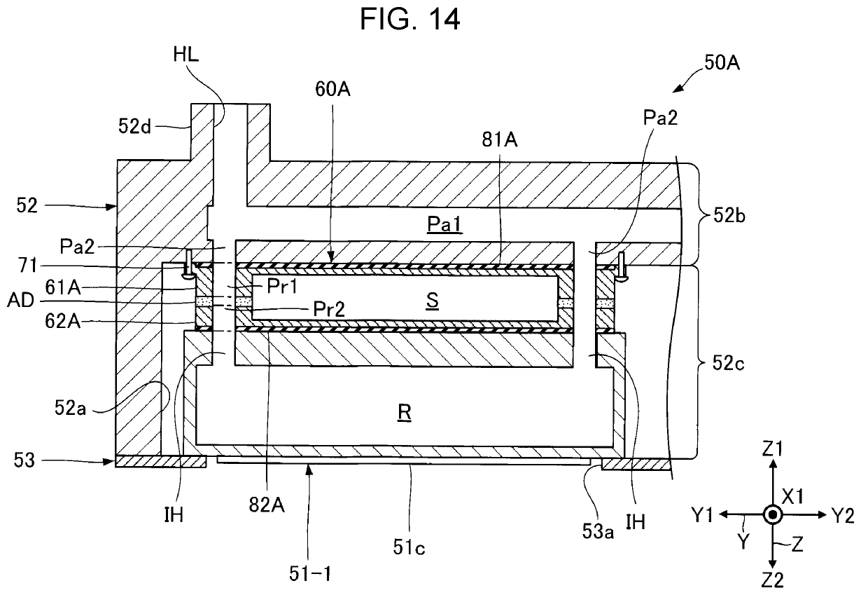

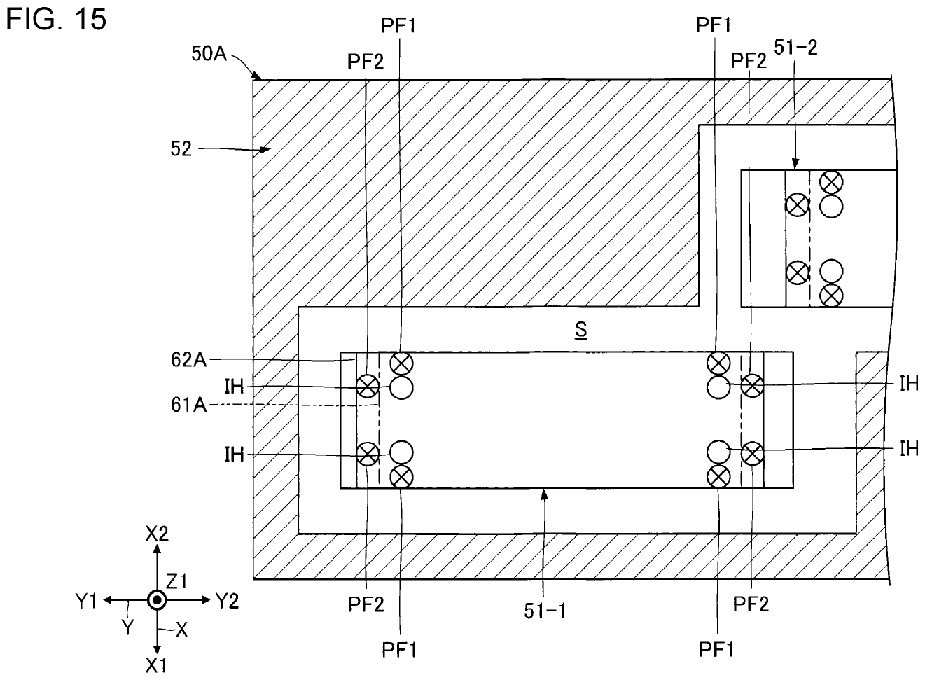

FIG. 13 is a cross-sectional view of a liquid ejecting head 50A according to the second embodiment. FIG. 14 is a cross-sectional view taken along the line XIV-XIV in FIG. 13. FIG. 15 is a schematic plan view for describing a first fixing position PF1 and a second fixing position PF2 according to the second embodiment. FIG. 15 schematically illustrates a relationship between the head chip 51 and the first fixing position PF1 and the second fixing position PF2 when viewed in the Z2 direction.

The liquid ejecting head 50A has the same configuration as the liquid ejecting head 50 of the first embodiment except that the liquid ejecting head 50A has a joint structure 60A instead of the joint structure 60. In FIG. 13, a joint structure 60A-1 is the joint structure 60A corresponding to the head chip 51-1, and a joint structure 60A-2 is the joint structure 60A corresponding to the head chip 51-2. In the following, each of the joint structure 60A-1 and the joint structure 60A-2 may be referred to as the joint structure 60A without distinguishing them.

The joint structure 60A has the same configuration as the joint structure 60 of the first embodiment except that the joint structure 60A has a first joint member 61A instead of the first joint member 61, a second joint member 62A instead of the second joint member 62, uses a sheet-shaped sealing member 81A instead of the sealing member 81, and uses a sheet-shaped sealing member 82A instead of the sealing member 82. Note that, in the above-described first embodiment, two joint structures 60 are used for one head chip 51, whereas in the present embodiment, one joint structure 60 is used for one head chip 51. Each of the sealing member 81A and the sealing member 82A has the same configuration as the sealing member 81 or the sealing member 82 of the first embodiment except that it has a sheet shape having a plurality of holes constituting a flow path. In the present embodiment, one sealing member 81A and one sealing member 82A are used for one head chip 51, respectively.

As illustrated in FIGS. 13 and 14, the first joint member 61A is configured so as to couple two adjacent first joint members 61 in the direction along the Y axis of the first embodiment, and has the same configuration as the first joint member 61 of the first embodiment except that the position of the first fixing position PF1 is different.

Similarly, the second joint member 62A is configured such that four second joint members 62 of the first embodiment are coupled, and has the same configuration as the second joint member 62 of the first embodiment except that the position of the second fixing position PF2 is different.

As illustrated in FIG. 15, each of the first joint member 61A and the second joint member 62A has a shape extending in the direction along the Y axis when viewed in the direction along the Z axis. Note that a width of the second joint member 62A along the Y axis is longer than a width of the first joint member 61A along the Y axis. Then, an end of the second joint member 62A in the Y1 direction is disposed in the Y1 direction from the first joint member 61A and an end of the second joint member 62A in the Y2 direction is disposed in the Y2 direction from the first joint member 61A. Accordingly, the second joint member 62A has two portions that do not overlap the first joint member 61A when viewed in the direction along the Z axis. Two second fixing positions PF2 are located at each of the two portions.

In addition, each of the first joint member 61A and the second joint member 62A is disposed inside the outer edge of the head chip 51 when viewed in the direction along the Z axis. Therefore, a distance between the two head chips 51 adjacent to each other in the direction along the X axis can be shortened as compared with the first embodiment described above. As a result, the size of the liquid ejecting head 50A can be reduced.

In the example illustrated in FIG. 15, a width of each of the first joint member 61A and the second joint member 62A along the X axis is equal to the width of the head chip 51 along the X axis. In this way, when viewed in the direction along the Z axis, the entire area of the first joint member 61A overlaps both the head chip 51 and the second joint member 62A. The first joint member 61A has four first fixing positions PF1. The respective shapes of the first joint member 61A and the second joint member 62A when viewed in the direction along the Z axis are not limited to the example illustrated in FIG. 15, and are set in any desired shape.

In this way, when viewed in the Z1 direction or the Z2 direction, which is the stacking direction of the head chip 51-1 and the flow path structure 52, each of the first fixing position PF1 and the second fixing position PF2 overlaps the head chip 51-1. Therefore, when detaching the head chip 51, it is necessary to release the bonding state by the adhesive AD. Releasing the bonding state means separation of the first joint member 61A and the second joint member 62A by any of cohesive failure caused by the failure of the adhesive AD, adhesive failure caused by the failure of the interface between the adhesive AD and the bonded material which is the first joint member 61A or the second joint member 62A, substrate failure caused by the failure of the bonded material, or by the failure of a mixture thereof. After that, the fastening state by the fixing member 71 can be released, or the fastening state by the fixing member 72 can be released.

With the second embodiment described above, by replacing the detached head chip 51 with another head chip 51, the liquid ejecting head 50A is regenerated or the detached head chip 51 is reused as a portion of another liquid ejecting head 50A.

In the present embodiment, as described above, the first fixing position PF1 for detachably fixing the first joint member 61A to the flow path structure 52 overlaps the head chip 51-1 when viewed in the stacking direction of the head chip 51-1 and the flow path structure 52.

Therefore, the size of the liquid ejecting head 50A can be reduced as compared with the aspect in which the first fixing position PF1 does not overlap the head chip 51-1 when viewed in the direction. Here, in order to detach the first joint member 61A from the flow path structure 52, the head chip 51-1 is detached and then the first joint member 61A is detached from the flow path structure 52 so that access to the first fixing position PF1 is possible by breaking the adhesive AD that bonds the first joint member 61A and the head chip 51-1 to each other.

### 3. THIRD EMBODIMENT

In the following, a third embodiment of the present disclosure will be described. In each embodiment exemplified in the following, for elements whose actions and functions are similar to those of the first embodiment, the reference numerals used in the explanation of the first embodiment are used and detailed explanation of each is appropriately omitted.

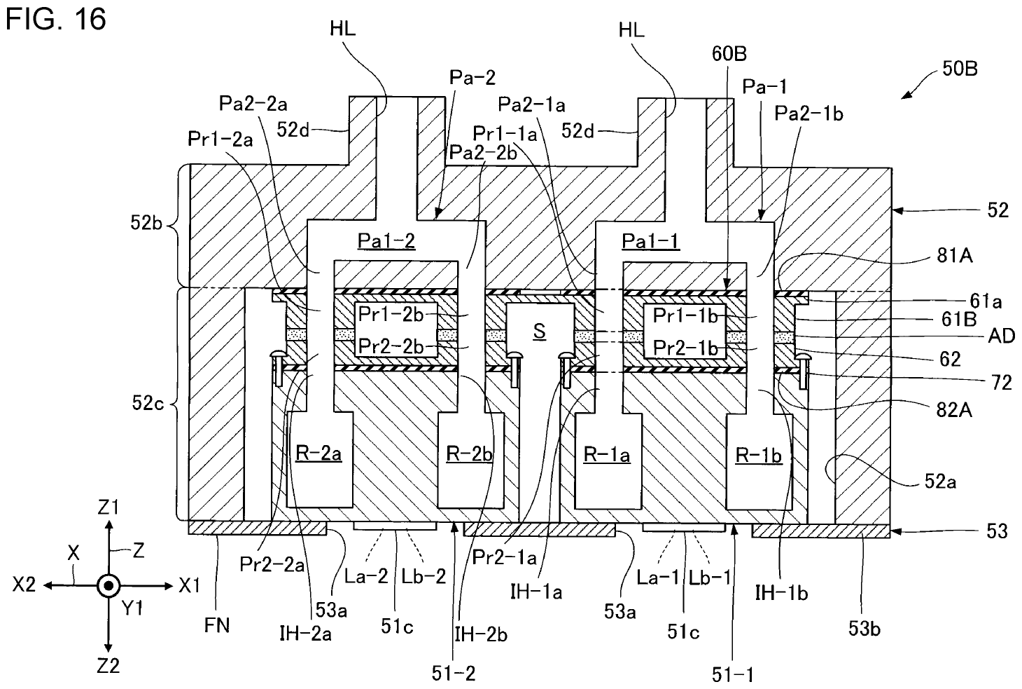

FIG. 16 is a cross-sectional view of a liquid ejecting head 50B according to a third embodiment. The liquid ejecting head 50B has the same configuration as the liquid ejecting head 50 of the first embodiment except that the liquid ejecting head 50B has a joint structure 60B instead of the joint structure 60 and the head chips 51-1 and 51-2 are disposed at the same position in the direction along the Y axis.

Here, the head chip 51-2 is an example of a “second head chip”, and each of the plurality of nozzles N constituting the nozzle row La-2 or the nozzle row Lb-2 is an example of a “second nozzle”. When each of the plurality of nozzles N constituting the nozzle row La-2 corresponds to a “second nozzle”, the inlet IH-2a is an example of a “fifth coupling flow path”. When each of the plurality of nozzles N constituting the nozzle row Lb-2 corresponds to a “second nozzle”, the inlet IH-2b is an example of a “fifth coupling flow path”. When each of the plurality of nozzles N constituting the nozzle row La-2 corresponds to a “second nozzle”, the branch flow path Pa2-2a is an example of a “sixth coupling flow path”. When each of the plurality of nozzles N constituting the nozzle row Lb-2 corresponds to a “second nozzle”, the branch flow path Pa2-2b is an example of a “sixth coupling flow path”. When each of the plurality of nozzles N constituting the nozzle row La-2 corresponds to a “second nozzle”, the relay flow path Pr1-2a is an example of a “fourth relay flow path”. When each of the plurality of nozzles N constituting the nozzle row Lb-2 corresponds to a “second nozzle”, the relay flow path Pr1-2b is an example of a “fourth relay flow path”.

The joint structure 60B has the same configuration as the joint structure 60 of the first embodiment except that the joint structure 60B has a first joint member 61B instead of the first joint member 61, uses the sheet-shaped sealing member 81A instead of the sealing member 81, and uses the sealing member 82A instead of the sealing member 82 as in the second embodiment described above. Note that, in the above-described first embodiment, two joint structures 60 are used for one head chip 51, whereas in the present embodiment, one joint structure 60B is used for two head chips 51. The sealing member 81A is not limited to an aspect in which the sealing member 81A is individually provided for each head chip 51, and may be provided for each joint structure 60B.

As illustrated in FIG. 16, the first joint member 61B is configured so as to couple two adjacent first joint members 61 in the direction along the Y axis of the first embodiment as in the above-described second embodiment. Not only that, it is configured so as to couple the two adjacent first joint members 61 in the direction along the X axis of the first embodiment. Therefore, by detaching the first joint member 61B from the flow path structure 52, the head chip 51-1 and the head chip 51-2 can be detached at the same time.

The first joint member 61B may be configured so as to couple two adjacent first joint members 61A in the direction along the Y axis of the second embodiment. In this case, by detaching the first joint member 61B from the flow path structure 52, the plurality of head chips 51 adjacent to each other in the direction along the Y axis can be detached at the same time. In addition, the second joint member 62 may be configured as one second joint member 62 common to the plurality of head chips 51 similar to the first joint member 61B.

With the third embodiment described above, by replacing the detached head chip 51 with another head chip 51, the liquid ejecting head 50B is regenerated or the detached head chip 51 is reused as a portion of another liquid ejecting head 50B.

As described above, the liquid ejecting head 50B of the present embodiment has the head chip 51-2 which is an example of a “second head chip”. The head chip 51-2 has the plurality of nozzles N constituting the nozzle row La-2 or the nozzle row Lb-2, and the inlet IH-2a or the inlet IH-2b which is an example of a “fifth coupling flow path”. Each of the plurality of nozzles N constituting the nozzle row La-2 or the nozzle row Lb-2 is an example of a “second nozzle”. The inlet IH-2a communicates with the plurality of nozzles N constituting the nozzle row La-2. The inlet IH-2b communicates with the plurality of nozzles N constituting the nozzle row Lb-2.

Here, the flow path structure 52 has the branch flow path Pa2-2a or the branch flow path Pa2-2b, which is an example of a “sixth coupling flow path”. Each of the branch flow path Pa2-2a and the branch flow path Pa2-2b is a flow path different from the branch flow path Pa2-1a. The first joint member 61B has the relay flow path Pr1-2a or the relay flow path Pr1-2b, which is an example of a “fourth relay flow path”. The relay flow path Pr1-2a communicates with the inlet IH-2a and the branch flow path Pa2-2a. The relay flow path Pr1-2b communicates with the inlet IH-2b and the branch flow path Pa2-2b.

The adhesive AD is disposed around the opening of the relay flow path Pr1-2a facing the inlet IH-2a, so that the relay flow path Pr1-2a and the inlet IH-2a liquid-tightly communicate with each other. Similarly, the adhesive AD is disposed around the opening of the relay flow path Pr1-2b facing the inlet IH-2b, so that the relay flow path Pr1-2b and the inlet IH-2b liquid-tightly communicate with each other. By using such a first joint member 61B, workability when collectively replacing the plurality of head chips 51 can be improved.

### 4. FOURTH EMBODIMENT

In the following, a fourth embodiment of the present disclosure will be described. In each embodiment exemplified in the following, for elements whose actions and functions are similar to those of the first embodiment, the reference numerals used in the explanation of the first embodiment are used and detailed explanation of each is appropriately omitted.

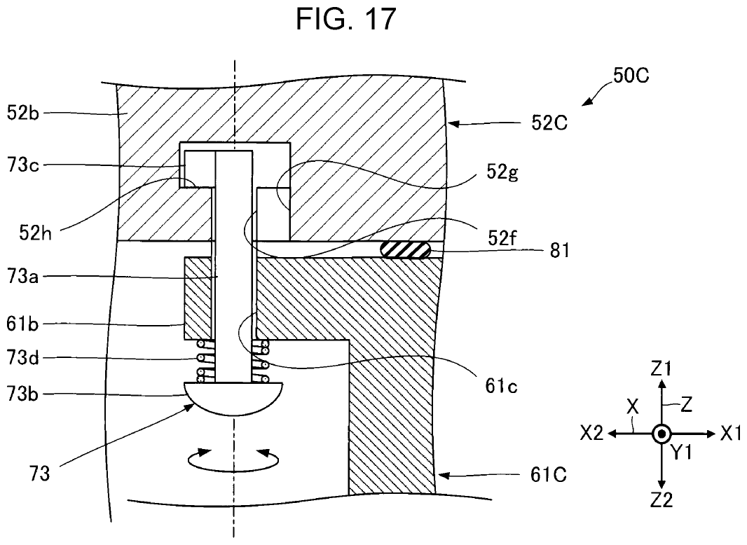

FIG. 17 is a view for describing a first joint member 61C of a liquid ejecting head 50C according to the fourth embodiment. The liquid ejecting head 50C has the same configuration as the liquid ejecting head 50 of the first embodiment except that the liquid ejecting head 50C has a flow path structure 52C, a first joint member 61C, and a fixing member 73 instead of the flow path structure 52, the first joint member 61, and the fixing member 71. The flow path structure 52C has the same configuration as the flow path structure 52 of the first embodiment, except for the configuration related to a fixing member 73 which will be described below. The first joint member 61C has the same configuration as the first joint member 61 of the first embodiment, except for the configuration related to the fixing member 73 which will be described below.

The fixing member 73 has a shaft portion 73a, a head portion 73b, a protrusion portion 73c, and a spring 73d. The shaft portion 73a has a rod shape extending along the Z axis. The head portion 73b is coupled to an end of the shaft portion 73a in the Z2 direction. The protrusion portion 73c protrudes outward in a radial direction of the shaft portion 73a from an end of the shaft portion 73a in the Z1 direction.

The first joint member 61C has a flange 61b, and a hole 61c is provided in the flange 61b. The hole 61c penetrates the flange 61b in the direction along the Z axis. The shaft portion 73a of the fixing member 73 is passed through the hole 61c so that the head portion 73b is disposed at a position in the Z2 direction with respect to the flange 61b. The hole 61c is configured to not allow the passage of the head portion 73b.

On the other hand, a recess 52f is provided on a surface of the flow path structure 52C facing the Z2 direction. The protrusion portion 73c of the fixing member 73 is disposed in the recess 52f. A groove 52g is provided in a portion of the recess 52f in a circumferential direction for allowing the entry of the protrusion portion 73c. In addition, at a position of a predetermined depth of the recess 52f, an accommodation portion 52h that is wide in the circumferential direction over a predetermined range is provided so that the protrusion portion 73c can be accommodated and a predetermined range of rotation of the shaft portion 73a is allowed. By adjusting the position of the protrusion portion 73c in the circumferential direction to the position of the groove 52g by the rotation of the shaft portion 73a, a state allowing movement of the protrusion portion 73c in the Z2 direction and a state restricting movement of the protrusion portion 73c in the Z2 direction by making the position of the protrusion portion 73c in the circumferential direction different from the position of the groove 52g can be switched.

Here, the spring 73d in a compressed state in the direction along the Z axis is disposed between the head portion 73b of the fixing member 73 and the flange 61b. Therefore, the protrusion portion 73c is biased in the Z2 direction by the spring 73d. Accordingly, in a state in which the movement of the protrusion portion 73c in the Z2 direction is restricted, the flow path structure 52C and the first joint member 61C are detachably fixed by the fixing member 73 and the spring 73d. The spring 73d is not limited to the illustrated coil spring and may be, for example, a leaf spring. In addition, depending on the thickness of the sealing member 81 and the like, the protrusion portion 73c may be biased in the Z2 direction by using an elastic force due to elastic deformation of the sealing member 81. In this case, the spring 73d may be omitted.

With the fourth embodiment described above, by replacing the detached head chip 51 with another head chip 51, the liquid ejecting head 50C is regenerated or the detached head chip 51 is reused as a portion of another liquid ejecting head 50C.

In the present embodiment, the fixing member 73 includes the spring 73d for generating an elastic force in a direction of bringing the first joint member 61C and the flow path structure 52C closer to each other. Therefore, the branch flow path Pa2-1a and the relay flow path Pr1-1a can be liquid-tightly coupled to each other. In addition, the first joint member 61C can be easily attached to and detached from the flow path structure 52C by a rotational operation of the fixing member 73.

The head chip 51 and the second joint member 62 may be detachably fixed to each other by using a fixing member similar to the fixing member 73 instead of the fixing member 72.

### 5. FIFTH EMBODIMENT

In the following, a fifth embodiment of the present disclosure will be described. In each embodiment exemplified in the following, for elements whose actions and functions are similar to those of the first embodiment, the reference numerals used in the explanation of the first embodiment are used and detailed explanation of each is appropriately omitted.

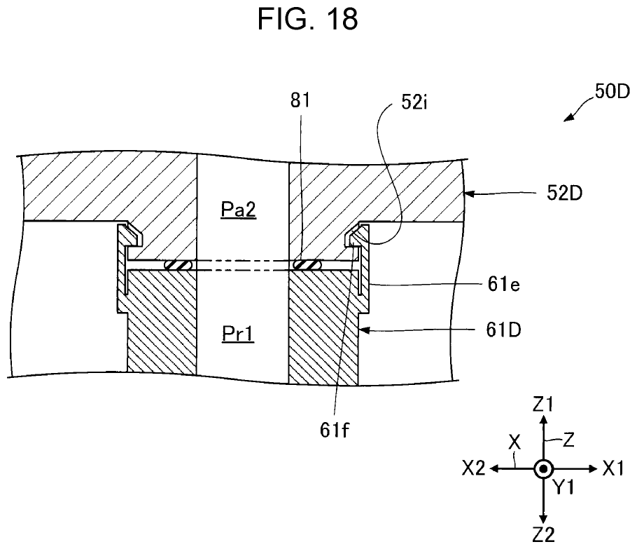

FIG. 18 is a view for describing a first joint member 61D of a liquid ejecting head 50D according to the fifth embodiment. The liquid ejecting head 50D has the same configuration as the liquid ejecting head 50 of the first embodiment except that the fixing member 71 is omitted, and the liquid ejecting head 50D has a flow path structure 52D and a first joint member 61D instead of the flow path structure 52 and the first joint member 61. The flow path structure 52D has the same configuration as the flow path structure 52 of the first embodiment, except for the configuration related to fixing with a first joint member 61D which will be described below. The first joint member 61D has the same configuration as the first joint member 61 of the first embodiment, except for the configuration related to fixing with the flow path structure 52D which will be described below.

The first joint member 61D has a plurality of elastic portions 61e and a plurality of claws 61f. Each of the plurality of elastic portions 61e is configured to be elastically deformable in a radial direction of the first joint member 61D. In the example illustrated in FIG. 18, the plurality of elastic portions 61e are disposed at intervals in a circumferential direction of the first joint member 61D, near a tip end of the first joint member 61D in the Z1 direction, and protrude toward the Z1 direction. A claw 61f that protrudes inward in the radial direction of the first joint member 61D is provided at the tip end of each elastic portion 61e.

A plurality of recesses 52i are provided in the flow path structure 52D. The plurality of recesses 52i are disposed at intervals in the circumferential direction of the first joint member 61D, corresponding to the plurality of claws 61f described above, and face outward in the radial direction of the first joint member 61D. The claw 61f enters each recess 52i. Accordingly, the movement of the first joint member 61D in the Z2 direction is restricted. In addition, the restriction can be released by deforming the elastic portion 61e outward in the radial direction.

With the fifth embodiment described above, by replacing the detached head chip 51 with another head chip 51, the liquid ejecting head 50D is regenerated or the detached head chip 51 is reused as a portion of another liquid ejecting head 50D.

In the present embodiment, as described above, the first joint member 61D has the claw 61f, which is an example of a “protrusion”. The claw 61f protrudes inward in a radial direction of the branch flow path Pa2-1a or the relay flow path Pr1-1a. On the other hand, the flow path structure 52D has a recess 52i that fits to the claw 61f. The first joint member 61D is detachably fixed to the flow path structure 52D by fitting the claw 61f and the recess 52i to each other. Therefore, the branch flow path Pa2-1a and the relay flow path Pr1-1a can be liquid-tightly coupled to each other. In addition, by fitting the claw 61f and the recess 52i or releasing the fitting, the first joint member 61D can be easily attached to and detached from the flow path structure 52D.

The flow path structure 52D may have a protrusion protruding outward or inward in the radial direction of the branch flow path Pa2-1a or the relay flow path Pr1-1a, and the first joint member 61D may have a recess that fits to the protrusion.

The head chip 51 and the second joint member 62 may be detachably fixed to each other by using a fixing method similar to the present embodiment instead of the fixing member 72.

### 6. SIXTH EMBODIMENT

In the following, a sixth embodiment of the present disclosure will be described. In each embodiment exemplified in the following, for elements whose actions and functions are similar to those of the first embodiment, the reference numerals used in the explanation of the first embodiment are used and detailed explanation of each is appropriately omitted.

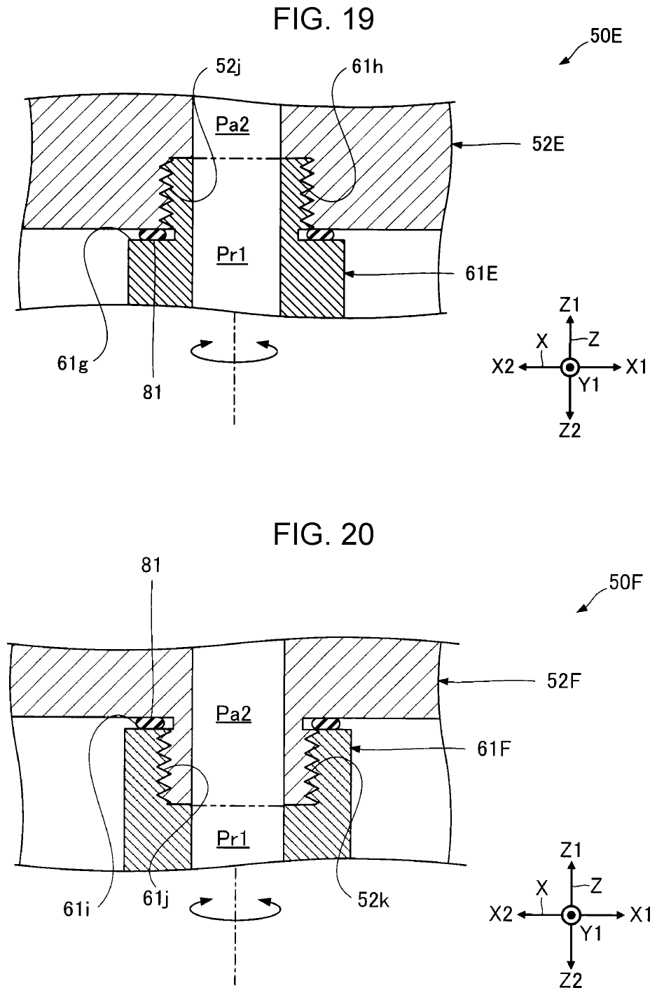

FIG. 19 is a view for describing a first joint member 61E of a liquid ejecting head 50E according to the sixth embodiment. The liquid ejecting head 50D has the same configuration as the liquid ejecting head 50 of the first embodiment except that the fixing member 71 is omitted, and the liquid ejecting head 50D has a flow path structure 52E and a first joint member 61E instead of the flow path structure 52 and the first joint member 61. The flow path structure 52E has the same configuration as the flow path structure 52 of the first embodiment, except for the configuration related to fixing with a first joint member 61E which will be described below. The first joint member 61E has the same configuration as the first joint member 61 of the first embodiment, except for the configuration related to fixing with a flow path structure 52E which will be described below.

The first joint member 61E has a male screw 61h around the central axis of the branch flow path Pa2-1a or the relay flow path Pr1-1a. A portion in which the male screw 61h is formed protrudes in the Z1 direction from a surface 61g of the first joint member 61 facing the Z1 direction. On the other hand, a female screw 52j around the central axis of the branch flow path Pa2-1a or the relay flow path Pr1-1a is formed at an inner peripheral surface of the recess formed at a surface of the flow path structure 52E facing the Z2 direction. The branch flow path Pa2 is open to a bottom surface of the recess. The female screw 52j fits into the male screw 61h. By this fitting, the flow path structure 52E and the first joint member 61E are detachably fixed to each other. In addition, this fixed state can be released by rotating one of the flow path structure 52E and the first joint member 61E with respect to the other.

Here, the sealing member 81 is disposed in an elastically deformed state between a surface of the flow path structure 52E facing the Z2 direction and the surface 61g of the first joint member 61E. The sealing member 81 may be disposed between a tip end surface of the portion in which the male screw 61h is formed and a bottom surface of the recess in which the female screw 52j is formed.

With the sixth embodiment described above, by replacing the detached head chip 51 with another head chip 51, the liquid ejecting head 50E is regenerated or the detached head chip 51 is reused as a portion of another liquid ejecting head 50E.

In the present embodiment, as described above, the first joint member 61E is provided with the male screw 61h around the central axis of the branch flow path Pa2-1a or the relay flow path Pr1-1a. On the other hand, the flow path structure 52E is provided with the female screw 52j fastened to the male screw 61h. The first joint member 61E is detachably fixed to the flow path structure 52E by fastening the male screw 61h and the female screw 52j. Therefore, the branch flow path Pa2-1a and the relay flow path Pr1-1a can be liquid-tightly coupled to each other. In addition, the first joint member 61E can be easily attached to and detached from the flow path structure 52E by a rotational operation without using a tool.

The head chip 51 and the second joint member 62 may be detachably fixed to each other by using a fixing method similar to the present embodiment instead of the fixing member 72.

### 7. SEVENTH EMBODIMENT

In the following, a seventh embodiment of the present disclosure will be described. In each embodiment exemplified in the following, for elements whose actions and functions are similar to those of the first embodiment, the reference numerals used in the explanation of the first embodiment are used and detailed explanation of each is appropriately omitted.

FIG. 20 is a view for describing a first joint member 61F of a liquid ejecting head 50F according to the seventh embodiment. The liquid ejecting head 50F has the same configuration as the liquid ejecting head 50 of the first embodiment except that the fixing member 71 is omitted, and the liquid ejecting head 50F has a flow path structure 52F and a first joint member 61F instead of the flow path structure 52 and the first joint member 61. The flow path structure 52F has the same configuration as the flow path structure 52 of the first embodiment, except for the configuration related to fixing with a first joint member 61F which will be described below. The first joint member 61F has the same configuration as the first joint member 61 of the first embodiment, except for the configuration related to fixing with a flow path structure 52F which will be described below.

The flow path structure 52F has a male screw 52k around the central axis of the branch flow path Pa2-1a or the relay flow path Pr1-1a. A portion in which the male screw 52k is formed protrudes in the Z2 direction from a surface of the flow path structure 52F facing the Z2 direction. On the other hand, a female screw 61j around the central axis of the branch flow path Pa2-1a or the relay flow path Pr1-1a is formed in an inner periphery of a recess formed at an end surface 61i of the first joint member 61F in the Z1 direction. The relay flow path Pr1 is open to a bottom surface of the recess. The female screw 61j fits into the male screw 52k. By this fitting, the flow path structure 52F and the first joint member 61F are detachably fixed to each other. In addition, this fixed state can be released by rotating one of the flow path structure 52F and the first joint member 61F with respect to the other.

Here, the sealing member 81 is disposed in an elastically deformed state between the end surface 61i and a surface of the flow path structure 52F facing the Z2 direction. The sealing member 81 may be disposed between a tip end surface of the portion in which the male screw 52k is formed and a bottom surface of the recess in which the female screw 61j is formed.

With the seventh embodiment described above, by replacing the detached head chip 51 with another head chip 51, the liquid ejecting head 50F is regenerated or the detached head chip 51 is reused as a portion of another liquid ejecting head 50F.

In the present embodiment, as described above, the flow path structure 52F is provided with the male screw 52k around the central axis of the branch flow path Pa2-1a or the relay flow path Pr1-1a. On the other hand, the first joint member 61F is provided with the female screw 61j fastened to the male screw 52k. The first joint member 61F is detachably fixed to the flow path structure 52F by fastening the male screw 52k and the female screw 61j. Therefore, the branch flow path Pa2-1a and the relay flow path Pr1-1a can be liquid-tightly coupled to each other. In addition, the first joint member 61F can be easily attached to and detached from the flow path structure 52F by a rotational operation without using a tool.

The head chip 51 and the second joint member 62 may be detachably fixed to each other by using a fixing method similar to the present embodiment instead of the fixing member 72.

### 8. EIGHTH EMBODIMENT

In the following, an eighth embodiment of the present disclosure will be described. In each embodiment exemplified in the following, for elements whose actions and functions are similar to those of the first embodiment, the reference numerals used in the explanation of the first embodiment are used and detailed explanation of each is appropriately omitted.

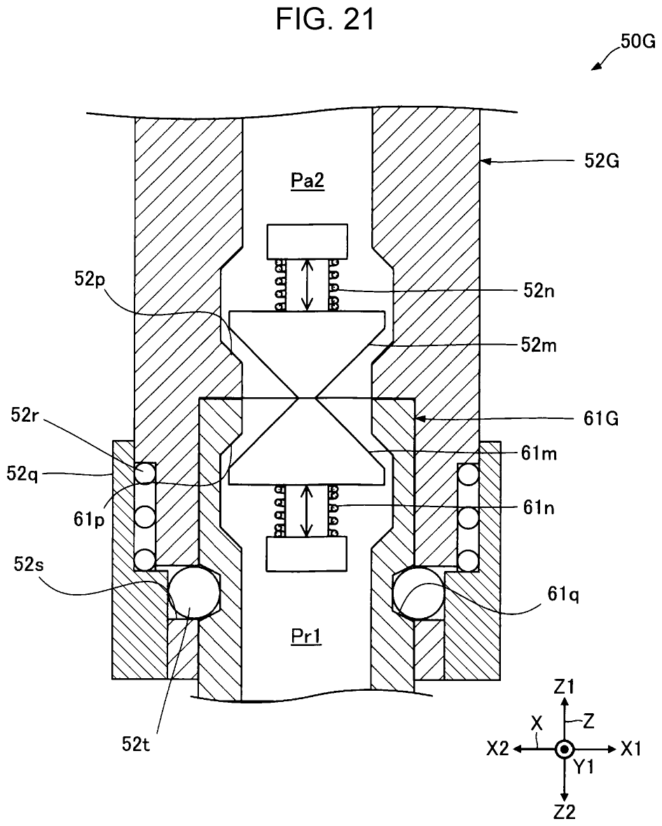

FIG. 21 is a view for describing a first joint member 61G of a liquid ejecting head 50G according to the eighth embodiment. The liquid ejecting head 50G has the same configuration as the liquid ejecting head 50 of the first embodiment except that the fixing member 71 is omitted, and the liquid ejecting head 50G has a flow path structure 52G and a first joint member 61G instead of the flow path structure 52 and the first joint member 61. The flow path structure 52G has the same configuration as the flow path structure 52 of the first embodiment, except for the configuration related to fixing with a first joint member 61G which will be described below. The first joint member 61G has the same configuration as the first joint member 61 of the first embodiment, except for the configuration related to fixing with a flow path structure 52G which will be described below. Although not illustrated in FIG. 21, in a state in which the first joint member 61G and the flow path structure 52G are coupled to each other, for disposing an elastic sealing member between them, the elastic sealing member is provided in the first joint member 61G or the flow path structure 52G.

The first joint member 61G has a so-called one-touch type male adapter structure. Specifically, the first joint member 61G has a valve body 61m and a spring 61n.

The valve body 61m is disposed movably in the direction along the Z axis in the relay flow path Pr1 of the first joint member 61G. The spring 61n is fixed to the first joint member 61G to bias the valve body 61m in the Z1 direction. Here, a valve seat 61p is provided on a wall surface of the relay flow path Pr1, and the valve body 61m moves in the Z2 direction against a biasing force of the spring 61n by contacting with a valve body 52m which will be described below. Accordingly, a gap is formed between the valve seat 61p and the valve body 61m. In addition, on an outer periphery of the first joint member 61G, a recess 61q into which a portion of a ball 52t, which will be described below, enters, is provided along the circumferential direction.

On the other hand, the flow path structure 52G has a so-called one-touch type female adapter structure. Specifically, the flow path structure 52G has the valve body 52m, a spring 52n, a sleeve 52q, a spring 52r, and a plurality of balls 52t.

The valve body 52m is disposed movably in the direction along the Z axis in the branch flow path Pa2 of the flow path structure 52G. The spring 52n is fixed to the flow path structure 52G to bias the valve body 52m in the Z2 direction. Here, a valve seat 52p is provided on a wall surface of the branch flow path Pa2, and the valve body 52m moves in the Z1 direction against a biasing force of the spring 52n by contacting with a valve body 61m which will be described below. Accordingly, a gap is formed between the valve seat 52p and the valve body 52m. The sleeve 52q is disposed movably in the direction along the Z axis outside the branch flow path Pa2. In addition, the sleeve 52q is configured to be switchable between a state in which outward movement of the ball 52t in the radial direction is restricted and a state in which the outward movement is allowed by the movement in the direction along the Z axis. The spring 52r is fixed to the flow path structure 52G to bias the sleeve 52q in the Z1 direction. The flow path structure 52G is provided with a plurality of holes 52s arranged in the circumferential direction and penetrating in the radial direction, and in each hole 52s, a ball 52t is disposed movably in the radial direction. In a state in which the outward movement in the radial direction is restricted by the sleeve 52q, a portion of each ball 52t enters the recess 61q described above, and thus the movement of the first joint member 61G in the Z2 direction with respect to the flow path structure 52G is restricted. In addition, by moving the sleeve 52q in the Z2 direction against the biasing force of the spring 52r, it is possible to make the sleeve 52q in a state in which the outward movement of the ball 52t in the radial direction is allowed. Accordingly, the ball 52t is retracted outward in the radial direction from the recess 61q, and thus, the first joint member 61G can be detached from the flow path structure 52G.

When the first joint member 61G is detached from the flow path structure 52G, the valve body 61m comes into contact with the valve seat 61p by the biasing force of the spring 61n. Accordingly, the relay flow path Pr1 is blocked. Similarly, when the first joint member 61G is detached from the flow path structure 52G, the valve body 52m comes into contact with the valve seat 52p by the biasing force of the spring 52n. Accordingly, the branch flow path Pa2 is blocked.

With the eighth embodiment described above, by replacing the detached head chip 51 with another head chip 51, the liquid ejecting head 50G is regenerated or the detached head chip 51 is reused as a portion of another liquid ejecting head 50G.

In the present embodiment, as described above, the flow path structure 52G has the ball 52t, and a portion of the ball 52t functions as a “protrusion”. The portion protrudes inward in a radial direction of the branch flow path Pa2-1a or the relay flow path Pr1-1a. On the other hand, the first joint member 61G has the recess 61q that fits to the portion of the ball 52t. The first joint member 61G is detachably fixed to the flow path structure 52G by fitting the portion of the ball 52t and the recess 61q into each other. Therefore, the branch flow path Pa2 and the relay flow path Pr1 can be liquid-tightly coupled to each other. In addition, by fitting the portion of the ball 52t and the recess 61q or releasing the fitting, the first joint member 61G can be easily attached to and detached from the flow path structure 52G.

In addition, as described above, the first joint member 61G can be opened and closed in an open state in which the branch flow path Pa2 and the relay flow path Pr1 communicate with each other while being attached to the flow path structure 52G, and in a closed state in which the relay flow path Pr1 is closed while being detached from the flow path structure 52G. Therefore, in a state in which the first joint member 61G is detached from the flow path structure 52G, it is possible to prevent the liquid from leaking from the relay flow path Pr1.

The head chip 51 and the second joint member 62 may be detachably fixed to each other by using a fixing method similar to the present embodiment instead of the fixing member 72.

### 9. MODIFICATION EXAMPLES

The forms exemplified above can be modified in various ways. Specific modified aspects that may be applied to the above-described embodiments are exemplified below. Any two or more aspects selected from the following examples can be combined as appropriate as long as there is no contradiction.

### 9-1. Modification Example 1

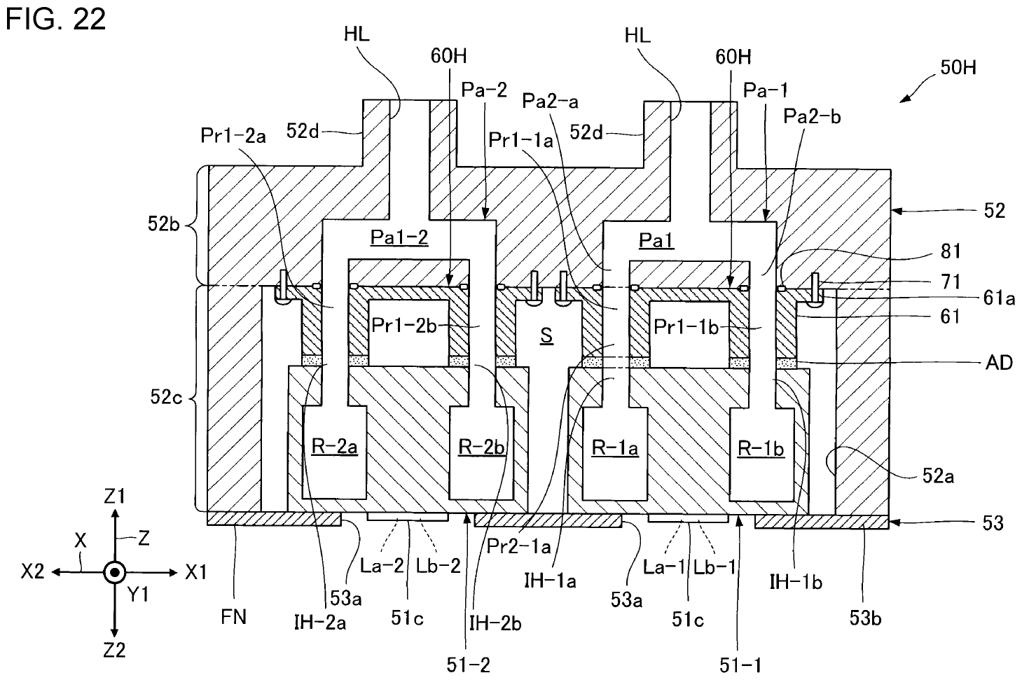

FIG. 22 is a cross-sectional view of a liquid ejecting head 50H according to Modification Example 1. The liquid ejecting head 50H has the same configuration as the liquid ejecting head 50 of the first embodiment except that the liquid ejecting head 50H has a joint structure 60H instead of the joint structure 60. The joint structure 60H has the same configuration as the joint structure 60 of the first embodiment except that the second joint member 62 is omitted. Here, the first joint member 61 is bonded to the head chip 51 via the adhesive AD. The adhesive AD is disposed around the opening of each inlet IH toward each branch flow path Pa2, so that each relay flow path Pr1 and each inlet IH are liquid-tightly coupled to each other.

In the above-described Modification Example 1, the adhesive AD is disposed around the opening of the inlet IH-1a toward the branch flow path Pa2-1a, so that the relay flow path Pr1-1a and the inlet IH-1a are liquid-tightly coupled to each other. In the liquid ejecting head 50H, when there is no purpose of reusing the head chip 51-1, the liquid ejecting head 50H can be easily regenerated by not using the second joint member 62, and thus cost for regenerating can be reduced.

### 9-2. Modification Example 2

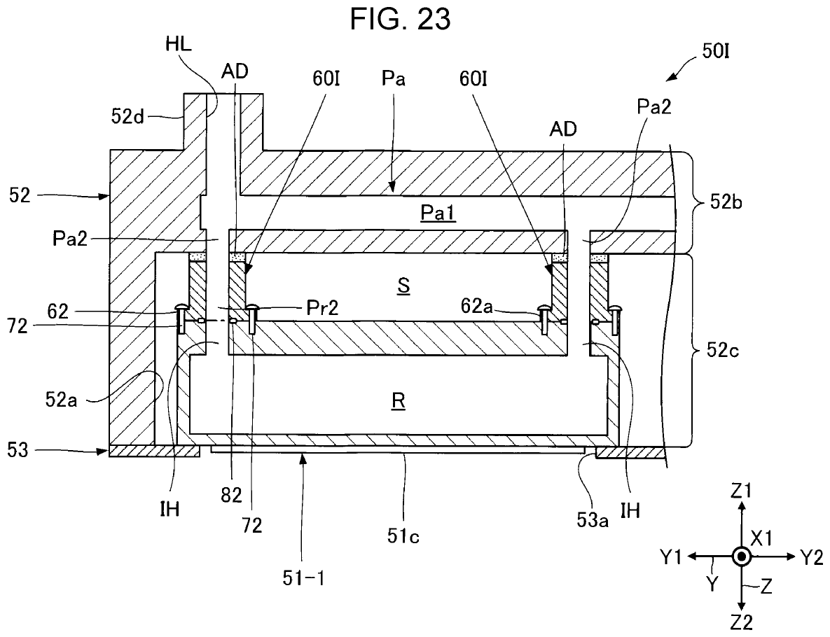

FIG. 23 is a cross-sectional view of a liquid ejecting head 50I according to Modification Example 2. In FIG. 23, a cross-sectional view of the liquid ejecting head 50I on the cutting surface corresponding to FIG. 7 is illustrated. The liquid ejecting head 50I has the same configuration as the liquid ejecting head 50 of the first embodiment except that the liquid ejecting head 50I has a joint structure 60I instead of the joint structure 60. The joint structure 60I has the same configuration as the joint structure 60 of the first embodiment except that the first joint member 61 is omitted. Here, the second joint member 62 is bonded to the flow path structure 52 via the adhesive AD. The adhesive AD is disposed around the opening of each branch flow path Pa2 toward each inlet IH, so that each relay flow path Pr2 and each inlet IH are liquid-tightly coupled to each other.

In the above-described Modification Example 2, the adhesive AD is disposed around the opening of the branch flow path Pa2 facing the inlet IH, so that the relay flow path Pr2 and the inlet IH are liquid-tightly coupled to each other. In the liquid ejecting head 50I, when there is no purpose of regenerating the liquid ejecting head 50I, more specifically, reusing the flow path structure 52, the reusable configuration of the head chip 51 can be realized at a low cost by not using the first joint member 61.

### 9-3. Modification Example 3

In the above-described embodiment, the relay flow path Pr1 of the first joint member 61 is liquid-tightly coupled to the branch flow path Pa2 of the flow path structure 52, but the present disclosure is not limited to this. For example, when the flow path Pa included in the flow path structure 52 is not composed of the common flow path Pa1 and a plurality of branch flow paths Pa2 branched from the common flow path Pa1 as above-described embodiment, but is composed as one flow path without branching from the opening HL to the head chip 51, the one flow path and the relay flow path Pr1 may be liquid-tightly coupled to each other. In addition, when the liquid ejecting head 50 includes a recovery flow path for recovering the liquid from the head chip 51 to the flow path structure 52, each of the branch flow path Pa2, the relay flow path Pr1, the relay flow path Pr2, and the inlet IH may be a portion of the recovery flow path.

### 9-4. Modification Example 4

In the above-described embodiments, an aspect in which the liquid ejecting head is a line type is exemplified, but the present disclosure is not limited to this aspect, and the liquid ejecting head may be a serial type in which the liquid ejecting head reciprocates in a width direction of the medium M.

### 9-5. Modification Example 5

The liquid ejecting apparatus exemplified in the above-described embodiments can be adopted in various types of apparatuses such as a facsimile apparatus and a copy machine, in addition to an apparatus dedicated to printing. However, the application of the liquid ejecting apparatus is not limited to the printing. For example, a liquid ejecting apparatus that ejects a solution of a coloring material is used as a manufacturing apparatus that forms a color filter of a display apparatus such as a liquid crystal display panel. In addition, a liquid ejecting apparatus that ejects a solution of a conductive material is used as a manufacturing apparatus that forms wirings or electrodes on a wiring substrate. In addition, a liquid ejecting apparatus that ejects a solution of an organic substance related to a living body is used, for example, as a manufacturing apparatus that manufactures a biochip.

What is claimed is:

1. A liquid ejecting head comprising:
a flow path structure having a first coupling flow path;
a first head chip having first nozzles configured to eject a liquid and a second coupling flow path that communicates with the first nozzles; and
a first joint member having a first relay flow path that communicates with the first coupling flow path and the second coupling flow path, wherein
the first joint member is detachably fixed to the flow path structure so that the first coupling flow path and the first relay flow path are coupled to each other, and
the second coupling flow path and the first relay flow path liquid-tightly communicate with each other via an adhesive disposed around an opening of the first relay flow path facing the second coupling flow path.

2. The liquid ejecting head according to claim 1, wherein
a first fixing position for detachably fixing the first joint member to the flow path structure overlaps the first head chip when viewed in a stacking direction of the first head chip and the flow path structure.

3. The liquid ejecting head according to claim 1, wherein
a first fixing position for detachably fixing the first joint member to the flow path structure does not overlap the first head chip when viewed in a stacking direction of the first head chip and the flow path structure.

4. The liquid ejecting head according to claim 3, further comprising:
a second joint member having a second relay flow path that communicates with the first coupling flow path via the first relay flow path and that communicates with the second coupling flow path, wherein
the second joint member is detachably fixed to the first head chip so that the second coupling flow path and the second relay flow path are coupled to each other,
the first relay flow path and the second relay flow path are liquid-tightly coupled to each other via the adhesive disposed around an opening of the second relay flow path facing the first coupling flow path, and
a second fixing position for detachably fixing the second joint member to the first head chip does not overlap the first joint member when viewed in the stacking direction.

5. The liquid ejecting head according to claim 1, further comprising:
a second joint member having a second relay flow path that communicates with the first coupling flow path via the first relay flow path and that communicates with the second coupling flow path, wherein
the second joint member is detachably fixed to the first head chip so that the second coupling flow path and the second relay flow path are coupled to each other, and
the first relay flow path and the second relay flow path are liquid-tightly coupled to each other via the adhesive disposed around an opening of the second relay flow path facing the first coupling flow path.

6. The liquid ejecting head according to claim 1, wherein
the first relay flow path and the second coupling flow path are liquid-tightly coupled to each other via the adhesive disposed around an opening of the second coupling flow path facing the first coupling flow path.

7. The liquid ejecting head according to claim 1, wherein
the adhesive is a thermosetting adhesive.

8. The liquid ejecting head according to claim 1, further comprising:
an elastic sealing member that liquid-tightly couples the first coupling flow path and the first relay flow path by being interposed between the first joint member and the flow path structure.

9. The liquid ejecting head according to claim 8, further comprising:
a fixing member that detachably fixes the first joint member to the flow path structure.

10. The liquid ejecting head according to claim 9, wherein
the fixing member is a screw that tightens the first joint member and the flow path structure together so as to compress the sealing member.

11. The liquid ejecting head according to claim 9, wherein
the fixing member includes a spring that generates an elastic force in a direction of bringing the first joint member and the flow path structure closer to each other.

12. The liquid ejecting head according to claim 1, wherein
a male screw is provided on one of the first joint member and the flow path structure, and a female screw fastened to the male screw is provided on another of the first joint member and the flow path structure, and
the first joint member is detachably fixed to the flow path structure by fastening the male screw and the female screw.

13. The liquid ejecting head according to claim 1, wherein
one of the first joint member and the flow path structure has a protrusion protruding outward or inward in a radial direction of the first coupling flow path or the first relay flow path, and another of the first joint member and the flow path structure has a recess that fits to the protrusion, and
the first joint member is detachably fixed to the flow path structure by fitting the protrusion and the recess to each other.

14. The liquid ejecting head according to claim 1, wherein
the flow path structure further has a third coupling flow path that is different from the first coupling flow path,
the first head chip further has a fourth coupling flow path that communicates with the third coupling flow path and that is different from the second coupling flow path,
the first joint member further has a third relay flow path that communicates with the third coupling flow path and the fourth coupling flow path, and
the fourth coupling flow path and the third relay flow path liquid-tightly communicate with each other via an adhesive disposed around an opening of the third relay flow path facing the fourth coupling flow path.

15. The liquid ejecting head according to claim 1, further comprising:
a second head chip having second nozzles configured to eject a liquid and a fifth coupling flow path that communicates with the second nozzles, wherein
the flow path structure further has a sixth coupling flow path that is different from the first coupling flow path,
the first joint member further has a fourth relay flow path that communicates with the fifth coupling flow path and the sixth coupling flow path, and
the fifth coupling flow path and the fourth relay flow path liquid-tightly communicate with each other via an adhesive disposed around an opening of the fourth relay flow path facing the fifth coupling flow path.

16. A liquid ejecting head comprising:
a flow path structure having a first coupling flow path;
a head chip having nozzles configure to eject a liquid and a second coupling flow path that communicates with the nozzles and that communicates with the first coupling flow path; and
a second joint member having a second relay flow path that communicates with the first coupling flow path and the second coupling flow path, wherein
the second joint member is detachably fixed to the head chip so that the second coupling flow path and the second relay flow path are coupled to each other, and
the first coupling flow path and the second relay flow path liquid-tightly communicate with each other via an adhesive disposed around an opening of the second relay flow path facing the first coupling flow path.

17. A liquid ejecting apparatus comprising:
the liquid ejecting head according to claim 1; and
a liquid storage portion for storing a liquid supplied to the liquid ejecting head.

18. A liquid ejecting apparatus comprising:
the liquid ejecting head according to claim 16; and
a liquid storage portion for storing a liquid supplied to the liquid ejecting head.
